(19) United States
(12) Patent Application Publication
(10) Pub. No.: US 2026/0008687 A1
(43) Pub. Date: Jan. 8, 2026

(54) METHOD FOR SYNTHESIZING A FERROELECTRIC-SEMICONDUCTOR COMPOSITE MATERIAL FOR ENHANCED ELECTROCATALYTIC AND ENERGY STORAGE APPLICATIONS

(71) Applicant: PRINCESS NOURAH BINT ABDULRAHMAN UNIVERSITY, Riyadh (SA)

(72) Inventors: Mohd. SHKIR, Abha (SA); Thamraa ALSHAHRANI, Riyadh (SA); Jagadeesha Angadi V, Karnataka (IN); Mohd DANISH, Abha (SA)

(73) Assignee: PRINCESS NOURAH BINT ABDULRAHMAN UNIVERSITY, Riyadh (SA)

(21) Appl. No.: 19/329,382

(22) Filed: Sep. 15, 2025

(51) Int. Cl. C01G 31/00; C25B 1/04; C25B 11/031; C25B 11/061; C25B 11/077; H01G 11/46

(52) U.S. Cl. CPC C01G 31/006; C25B 11/031; C25B 11/061; C25B 11/077; H01G 11/46; C01P 2002/72; C01P 2002/82; C01P 2002/84; C01P 2004/61; C01P 2004/64; C01P 2006/40; C01P 2006/42; C25B 1/04

(57) ABSTRACT

A method for synthesizing a ferroelectric-semiconductor composite material with enhanced electrocatalytic and energy storage properties. The process involves synthesizing BiVO₄ powder by mixing Bi₂O₃ and V₂O₅ with ethanol, grinding the mixture for about 3 hours, pressing into a pellet, and calcining it between 500-1000° C. for 2-6 hours, followed by re-calcination at 700° C. for 2 hours. In parallel, BaTiO₃ powder is synthesized by mixing and grinding BaCO₃ and TiO₂ for 4 hours, pelletizing the mixture, and calcining it at 1300° C. for 4 hours. The resulting BiVO₄ and BaTiO₃ powders are mixed in molar ratios of (1−x):x and ground for approximately 1 hour to form a uniform mixture, which is then pressed into a pellet and calcined at 700° C. for 4 hours. Upon cooling, a (1−x)BaTiO₃+xBiVO₄ composite is obtained. This composite exhibits synergistic properties advantageous for electrocatalysis and energy storage applications.

### FIELD OF THE INVENTION

The present disclosure relates generally to the field of materials science, and more particularly to the synthesis of advanced composite materials. Specifically, it pertains to a method for synthesizing a ferroelectric-semiconductor composite material designed for enhanced performance in electrocatalytic processes and various energy storage applications. The invention further relates to an electrochemical device incorporating this innovative composite material, thereby contributing to advancements in sustainable energy technologies and high-efficiency electrochemical systems.

### BACKGROUND OF THE INVENTION

Hydrogen evolution reaction (HER) is a critical component in electrochemical water splitting, offering a sustainable pathway to produce clean hydrogen fuel. Conventional HER catalysts, such as noble metals (e.g., platinum), provide excellent performance but suffer from high cost and scarcity, limiting their practical deployment in large-scale applications. As a result, there is a growing interest in developing alternative, cost-effective, and efficient electrocatalysts based on metal oxides and hybrid materials.

Ferroelectric materials like barium titanate (BaTiO₃) have long been studied for their high dielectric constants, spontaneous polarization, and piezoelectric properties. These characteristics make BaTiO₃ attractive in capacitors, actuators, and energy storage devices. However, BaTiO₃ alone is not ideal for photocatalytic or electrocatalytic applications due to its wide bandgap (˜3.2 eV), which limits visible light absorption and catalytic activity.

On the other hand, bismuth vanadate (BiVO₄) is a visible-light-active semiconductor with a narrow bandgap (˜2.4 eV) and has been widely explored for photocatalytic water splitting and environmental remediation. Despite its promising photocatalytic properties, BiVO₄ suffers from poor charge mobility and high recombination rates of photogenerated charge carriers, which hinder its catalytic efficiency.

Prior efforts have focused on doping, nanostructuring, or forming heterojunctions to enhance the charge transport and optical properties of BiVO₄-based systems. Similarly, researchers have investigated BaTiO₃-based composites for coupling ferroelectric effects with photocatalytic behavior. However, existing systems often lack a rationally engineered interface that combines the ferroelectric field-induced charge separation of BaTiO₃ with the visible-light response of BiVO₄ in a structurally and compositionally tunable manner.

Furthermore, while some BaTiO₃-semiconductor composites have demonstrated improved photocatalytic properties, comprehensive studies integrating structural analysis, magnetic behavior, electrochemical performance, and theoretical validation through density functional theory (DFT) are still limited.

Traditional semiconductor catalysts often suffer from rapid charge carrier recombination, limited surface activity, and narrow tunability of optical and electronic properties. Ferroelectric materials like BaTiO₃ possess intrinsic electric polarization which can be used to overcome these limitations through interface engineering with semiconductors. However, effective composite systems that utilize this synergistic interaction for hydrogen evolution and energy storage have not been widely developed.

Thus, there remains a significant need for multifunctional heterostructured materials that can synergistically exploit the ferroelectric and semiconducting properties to achieve enhanced electrocatalytic performance, particularly for HER applications under visible light. The present invention addresses this gap by introducing a tunable BaTiO₃—BiVO₄ composite system with optimized band alignment and interfacial charge transfer characteristics for high-efficiency hydrogen evolution and energy storage.

### SUMMARY OF THE INVENTION

The present disclosure seeks to provide a method for synthesizing a ferroelectric-semiconductor composite material and, a compositionally tunable (1−x)BaTiO₃+xBiVO₄ composite device that integrates the ferroelectric characteristics of BaTiO₃ with the narrow-bandgap semiconducting properties of BiVO₄. Through strategic synthesis, interfacial engineering, and compositional variation, the device exhibits enhanced photocatalytic and electrocatalytic performance, particularly in hydrogen evolution reactions (HER). The invention achieves controlled bandgap tuning from approximately 3.2 eV (for BaTiO₃) to approximately 2.4 eV (for BiVO₄), which is crucial for optimized light absorption. Furthermore, it establishes a Type-II band alignment across the BaTiO₃—BiVO₄ interface, thereby facilitating efficient charge separation and directional electron transport within the composite material. A significant reduction in overpotential and Tafel slope has been observed in hydrogen evolution reaction (HER) activity, with optimal performance demonstrated at an x=0.9 composition. These enhanced dielectric and electrochemical properties are rigorously supported by both experimental validation and Density Functional Theory (DFT)-based theoretical calculations.

In an embodiment, a ferroelectric-semiconductor composite material composition for enhanced electrocatalytic and energy storage applications, comprises: 100-0 wt. % of BiVO₄ powder; and 0-100 wt. % of BaTiO₃ powder.

In another embodiment, a method for synthesizing a ferroelectric-semiconductor composite material for enhanced electrocatalytic and energy storage applications is disclosed. The method includes synthesizing BiVO₄ powder upon treating Bi₂O₃ with V₂O₅. The BiVO₄ powder synthesis comprising: mixing and grinding Bi₂O₃ and V₂O₅ with ethanol for approximately 3 hours to form a mixture; pressing the mixture into a second pellet; calcining the second pellet at approximately 500-1000° C. for approximately 2-6 hours; allowing the second pellet to cool naturally to room temperature; grinding the cooled second pellet into a BiVO₄ powder; and re-calcining the BiVO₄ powder at approximately 700° C. for approximately 2 hours.

The method further includes synthesizing BaTiO₃ powder upon treating BaCO₃ with TiO₂. BaTiO₃ powder synthesis comprising: mixing and grinding BaCO₃ and TiO₂ for approximately 4 hours to form a mixture; pressing the mixture into a third pellet; calcining the third pellet at approximately 1000-1500° C. for approximately 2-6 hours; and allowing the third pellet to cool naturally to room temperature.

The method further includes mixing the synthesized BiVO₄ powder and BaTiO₃ powder in molar ratios of (1−x):x for approximately 1 hour to form a mixture.

The method further includes pressing the mixture into a first pellet.

The method further includes calcining the first pellet at approximately 700° C. for approximately 4 hours thereby cooling the pellet to room temperature to form a (1−x)BaTiO₃+xBiVO₄ composite.

In a further embodiment, an electrochemical device is disclosed. The device includes a working electrode coated with a composite material having a composition of (1−x)BaTiO₃+xBiVO₄, where 0≤x≤1, wherein the working electrode is prepared by a drop casting technique, upon: dispersing approximately 10 mg of the pre-synthesized BiVO₄—BaTiO₃ composite powder in approximately 1 mL of ethanol, and adding one drop of a Nafion binder, thereby ultrasonicating the mixture for a period of at least 20 minutes to obtain a catalyst suspension.

The device further includes a current collector substrate selected from carbon cloth, nickel foam, or conductive glass, wherein a drop of the well-dispersed catalyst suspension is pippeted onto a cleaned glassy carbon electrode substrate, and the coated substrate is dried in a mild oven at approximately 60° C. for approximately 30-60 minutes to evaporate the solvent and fix the composite layer.

The device further includes an electrolyte suitable for hydrogen generation or energy storage.

The device further includes a counter-electrode and reference electrode configured in a three-electrode system, wherein the counter-electrode is a graphene-based electrode, configured to substantially prevent the dissolution and redeposition of platinum onto the working electrode surface during electrochemical measurements, thereby ensuring that the measured activity originates solely from the composite catalyst, wherein the electrochemical measurements are conducted in a 1M NaOH electrolyte, and further wherein the potential measurements are converted from an Ag/AgCl reference electrode to a reversible hydrogen electrode (RHE) scale, wherein the device is configured to perform hydrogen evolution or operate as a supercapacitor.

An object of the present disclosure is to develop a compositionally tunable (1−x)BaTiO₃+xBiVO₄ composite system that effectively integrates ferroelectric and narrow-bandgap semiconducting properties.

Another object of the present disclosure is to achieve controlled bandgap tuning for optimized light absorption and establish a Type-II band alignment to facilitate efficient charge separation and transport.

Another object of the present disclosure is to enhance electrocatalytic performance, particularly in hydrogen evolution reactions (HER), by reducing overpotential and Tafel slope.

Yet another object of the present invention is to deliver an expeditious and cost-effective material with improved dielectric and electrochemical properties for advanced energy storage applications.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of an electrochemical device in accordance with an embodiment of the present disclosure.

FIG. 2 illustrates a flow chart of a method for synthesizing a ferroelectric-semiconductor composite material for enhanced electrocatalytic and energy storage applications in accordance with an embodiment of the present disclosure.

FIG. 3 illustrates an XRD (1−x)BaTiO₃+x(BiVO₄) (where x=0, 0.05,0.1,0.5, 0.9 and 1) composite.

FIG. 4(a) illustrates XRF spectrum of BiVO₄ with characteristic Bi and V peaks.

FIG. 4(a′) illustrates Elemental mapping of BiVO₄ confirming homogeneous Bi and V distribution.

FIG. 4(b) illustrates XRF spectrum of 0.95BiVO₄ composite with additional Ti and Ba peaks.

FIG. 4(b′) illustrates Elemental mapping of 0.95BiVO₄ composite showing Bi, V, Ti, and Ba presence.

FIG. 4(c) illustrates XRF spectrum of 0.9BiVO₄ composite containing Bi, V, Ti, and Ba elements.

FIG. 4(c′) illustrates Elemental mapping of 0.9BiVO₄ composite displaying multi-element distribution.

FIG. 4(d) illustrates XRF spectrum of 0.5BiVO₄ composite with distinct Bi, V, Ti, and Ba peaks.

FIG. 4(d′) illustrates Elemental mapping of 0.5BiVO₄ composite confirming uniform multi-element dispersion.

FIG. 5(a) illustrates XRF spectrum of 0.1BiVO₄ composite identifying Bi, V, Ti, and Ba peaks.

FIG. 5(a′) illustrates Elemental mapping of 0.1BiVO₄ composite confirming dispersion of Bi, V, Ti, and Ba.

FIG. 5(b) illustrates XRF spectrum of 0.05BiVO₄ composite with Bi, V, Ti, and Ba signals.

FIG. 5 (b′) illustrates Elemental mapping of 0.05BiVO₄ composite showing distribution of Bi, V, Ti, and Ba.

FIG. 5(c) illustrates XRF spectrum of BaTiO₃ with Ti and Ba peaks.

FIG. 5(c′) illustrates Elemental mapping of BaTiO₃ confirming Ti and Ba uniformity.

FIG. 6(a) illustrates Optical micrograph of BaTiO₃ (x=0) composite at 300 μm scale.

FIG. 6(b) illustrates Optical micrograph of 0.05BiVO₄+0.95BaTiO₃ (x=0.05) composite at 300 μm scale.

FIG. 6(c) illustrates Optical micrograph of 0.1BiVO₄+0.9BaTiO₃ (x=0.1) composite at 300 μm scale.

FIG. 6(d) illustrates Optical micrograph of 0.5BiVO₄+0.5BaTiO₃ (x=0.5) composite at 300 μm scale.

FIG. 6(e) illustrates Optical micrograph of 0.9BiVO₄+0.1BaTiO₃ (x=0.9) composite at 300 μm scale.

FIG. 6(f) illustrates Optical micrograph of 0.95BiVO₄+0.05BaTiO₃ (x=0.95) composite at 300 μm scale.

FIG. 6(g) illustrates Optical micrograph of BiVO₄ (x=1) composite at 300 μm scale.

FIG. 7 illustrates Raman spectrum of (1−x)BiVO₄-xBaTiO₃ composites;

FIG. 8 illustrates Fourier-transform infrared (FTIR) spectroscopy analysis of FTIR spectra of (1−x)BiVO₄-xBaTiO₃ composites;

FIG. 9(a) illustrates UV-Vis DRS spectrum of BiVO₄ with absorption edge near 520 nm.

FIG. 9(a′) illustrates Optical bandgap of BiVO₄ determined as 2.37 eV.

FIG. 9(b) illustrates UV-Vis DRS spectrum of 0.95BiVO₄ composite with absorption edge near 512 nm.

FIG. 9(b′) illustrates Optical bandgap of 0.95BiVO₄ composite determined as 2.42 eV.

FIG. 9(c) illustrates UV-Vis DRS spectrum of 0.9BiVO₄ composite with absorption edge near 510 nm.

FIG. 9(c′) illustrates Optical bandgap of 0.9BiVO₄ composite determined as 2.43 eV.

FIG. 9(d) illustrates UV-Vis DRS spectrum of 0.5BiVO₄ composite with absorption edge near 420 nm.

FIG. 9(d′) illustrates Optical bandgap of 0.5BiVO₄ composite determined as 2.95 eV.

FIG. 10(a) illustrates UV-Vis DRS spectrum of 0.1BiVO₄ composite with absorption edge near 390 nm.

FIG. 10(a′) illustrates Optical bandgap of 0.1BiVO₄ composite determined as 3.17 eV.

FIG. 10(b) illustrates UV-Vis DRS spectrum of 0.05BiVO₄ composite with absorption edge near 388 nm.

FIG. 10(b′) illustrates Optical bandgap of 0.05BiVO₄ composite determined as 3.20 eV.

FIG. 10(c) illustrates UV-Vis DRS spectrum of BaTiO₃ with absorption edge near 396 nm.

FIG. 10(c′) illustrates Optical bandgap of BaTiO₃ determined as 3.13 eV.

FIG. 11(a) illustrates Magnetic hysteresis loop of BiVO₄ measured at room temperature.

FIG. 11(b) illustrates Magnetic hysteresis loop of 0.95BiVO₄ composite.

FIG. 11(c) illustrates Magnetic hysteresis loop of 0.9BiVO₄ composite.

FIG. 11(d) illustrates Magnetic hysteresis loop of 0.5BiVO₄ composite.

FIG. 11(e) illustrates Magnetic hysteresis loop of 0.1BiVO₄ composite.

FIG. 11(f) illustrates Magnetic hysteresis loop of 0.05BiVO₄ composite.

FIG. 11(g) illustrates Magnetic hysteresis loop of BaTiO₃.

FIG. 11(h) illustrates Variation of coercivity (Hc) and remanent magnetization (Mr) as a function of BiVO₄ concentration in (1−x)BiVO₄+xBaTiO₃ composites.

FIG. 12(a) illustrates FORC curve of 0.1BiVO₄ composite.

FIG. 12(a′) illustrates FORC distribution contour map of 0.1BiVO₄ composite.

FIG. 12(b) illustrates FORC curve of 0.05BiVO₄ composite.

FIG. 12(b′) illustrates FORC distribution contour map of 0.05BiVO₄ composite.

FIG. 12(c) illustrates FORC curve of BaTiO₃.

FIG. 12(c′) illustrates FORC distribution contour map of BaTiO₃.

FIG. 13(a) illustrates Linear sweep voltammetry curves of BiVO₄, 0.95BiVO₄, 0.9BiVO₄, and 0.5BiVO₄ composites.

FIG. 13(b) illustrates Tafel slope values extracted for BiVO₄ and BiVO₄—BaTiO₃ composites.

FIG. 13(c) illustrates Cyclic voltammetry response of BiVO₄ at varying scan rates.

FIG. 13(d) illustrates Cyclic voltammetry response of 0.95BiVO₄ composite at varying scan rates.

FIG. 13(e) illustrates Cyclic voltammetry response of 0.9BiVO₄ composite at varying scan rates.

FIG. 13(f) illustrates Cyclic voltammetry response of 0.5BiVO₄ composite at varying scan rates.

FIG. 13(g) illustrates Double-layer capacitance (Cdl) estimation from CV curves of BiVO₄ and composites.

FIG. 13(h) illustrates Electrochemical impedance spectroscopy (Nyquist plot) of BiVO₄ and composites.

FIG. 13(i) illustrates Bode phase angle plots of BiVO₄ and composites.

FIG. 14(a) illustrates Linear sweep voltammetry curves of 0.1BiVO₄, 0.05BiVO₄, and BaTiO₃ composites.

FIG. 14(b) illustrates Tafel slope plots derived from polarization data of 0.1BiVO₄, 0.05BiVO₄, and BaTiO₃.

FIG. 14(c) illustrates Cyclic voltammetry curves of 0.1BiVO₄ at varying scan rates.

FIG. 14(d) illustrates Cyclic voltammetry curves of 0.05BiVO₄ at varying scan rates.

FIG. 14(e) illustrates Cyclic voltammetry curves of BaTiO₃ at varying scan rates.

FIG. 14(f) illustrates Linear fit of capacitive current versus scan rate for double-layer capacitance evaluation.

FIG. 14(g) illustrates Nyquist impedance plot from EIS measurements of 0.1BiVO₄, 0.05BiVO₄, and BaTiO₃ composites.

FIG. 14(h) illustrates Bode phase angle response of 0.1BiVO₄, 0.05BiVO₄, and BaTiO₃ composites.

FIG. 14(i) illustrates Bode impedance plots of 0.1BiVO₄, 0.05BiVO₄, and BaTiO₃ composites.

FIGS. 15A illustrates a Table depicting weight of BiVO₄, with BaTiO₃.

FIGS. 15B illustrates a Table depicting weight of Bi₂O₃, with V₂O₅.

FIGS. 15C illustrates a Table depicting weight of BaCO₃, with TiO₂.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION:

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

In an embodiment, a ferroelectric-semiconductor composite material composition for enhanced electrocatalytic and energy storage applications, comprises: 100-0 wt. % of BiVO₄ powder; and 0-100 wt. % of BaTiO₃ powder.

In another embodiment, the weight percentage of the BiVO₄ powder and BaTiO₃ powder, is 13.37, and 86.63, respectively.

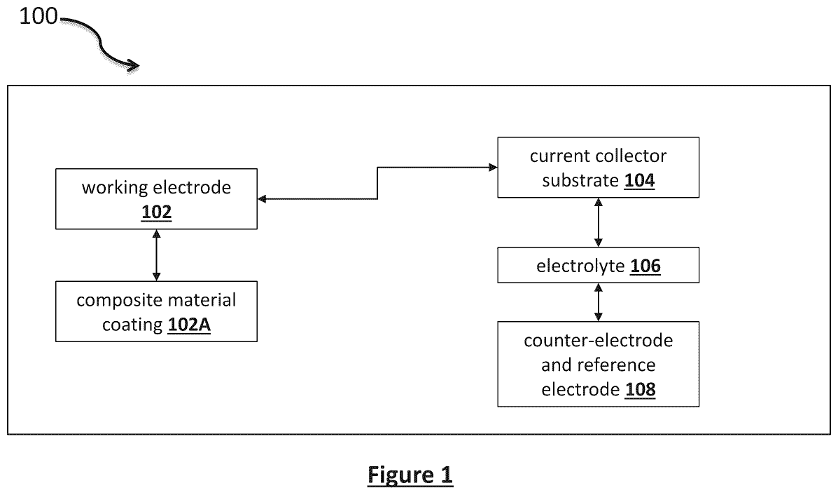

Referring to FIG. 1, a block diagram of an electrochemical device is illustrated in accordance with an embodiment of the present disclosure. The device includes a working electrode (102) coated with a composite material (102A) having a composition of (1−x)BaTiO₃+xBiVO₄, where 0≤x≤1, wherein the working electrode is prepared by a drop casting technique, upon: dispersing approximately 10 mg of the pre-synthesized BiVO₄—BaTiO₃ composite powder in approximately 1 mL of ethanol, and adding one drop of a Nafion binder, thereby ultrasonicating the mixture for a period of at least 20 minutes to obtain a catalyst suspension.

In an embodiment, a current collector substrate (104) selected from carbon cloth, nickel foam, or conductive glass, wherein a drop of the well-dispersed catalyst suspension is pippeted onto a cleaned glassy carbon electrode substrate, and the coated substrate is dried in a mild oven at approximately 60° C. for approximately 30-60 minutes to evaporate the solvent and fix the composite layer.

In an embodiment, an electrolyte (106) suitable for hydrogen generation or energy storage. In an embodiment, a counter-electrode and reference electrode (108) configured in a three-electrode system, wherein the counter-electrode is a graphene-based electrode, configured to substantially prevent the dissolution and redeposition of platinum onto the working electrode surface during electrochemical measurements, thereby ensuring that the measured activity originates solely from the composite catalyst, wherein the electrochemical measurements are conducted in a 1M NaOH electrolyte, and further wherein the potential measurements are converted from an Ag/AgCl reference electrode to a reversible hydrogen electrode (RHE) scale, wherein the device is configured to perform hydrogen evolution or operate as a supercapacitor.

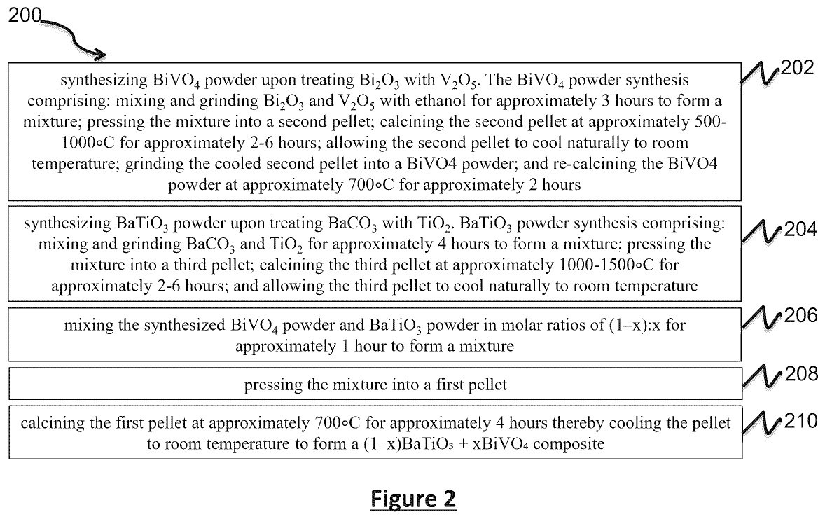

FIG. 2 illustrates a flow chart of a method for synthesizing a ferroelectric-semiconductor composite material for enhanced electrocatalytic and energy storage applications in accordance with an embodiment of the present disclosure. At step (202), the method (200) includes synthesizing BiVO₄ powder upon treating Bi₂O₃ with V₂O₅.

At step (204), the method (200) includes synthesizing BaTiO₃ powder upon treating BaCO₃ with TiO₂.

At step (206), the method (200) includes mixing the synthesized BiVO₄ powder and BaTiO₃ powder in molar ratios of (1−x):x for approximately 1 hour to form a mixture.

At step (208), the method (200) includes pressing the mixture into a first pellet.

At step (210), the method (200) includes calcining the first pellet at approximately 700° C. for approximately 4 hours thereby cooling the pellet to room temperature to form a (1−x)BaTiO₃+xBiVO₄ composite.

In another embodiment, the BiVO₄ powder synthesis comprising mixing and grinding Bi₂O₃ and V₂O₅ with ethanol for approximately 3 hours to form a mixture. Then, pressing the mixture into a second pellet. Then, calcining the second pellet at approximately 500-1000° C. for approximately 2-6 hours. Then, allowing the second pellet to cool naturally to room temperature. Then, grinding the cooled second pellet into a BiVO₄ powder. Then, re-calcining the BiVO₄ powder at approximately 700° C. for approximately 2 hours.

In some embodiments, the second pellet is calcinated in a muffle furnace at approximately 700° C. for approximately 4 hours.

In further embodiment, the BaTiO₃ powder synthesis comprising mixing and grinding BaCO₃ and TiO₂ for approximately 4 hours to form a mixture. Then, pressing the mixture into a third pellet. Then, calcining the third pellet at approximately 1000-1500° C. for approximately 2-6 hours. Then, allowing the third pellet to cool naturally to room temperature.

In the above embodiments, the grinding steps are performed in an agate mortar.

Still, in some embodiments, the third pellet is calcinated in a high-temperature furnace at approximately 1300° C. for approximately 4 hours.

In some embodiments, the molar ratio x for the composite material is selected from the group consisting of 0,0.05,0.1,0.5,0.9, and 0.95, wherein the composite material comprises 95 mol % BiVO₄ and 5 mol % BaTiO₃, exhibiting optimal electrocatalytic performance.

In another embodiment, the bandgap of the composite is tunable between 3.2 eV for BaTiO₃ and 2.4 eV for BiVO₄, enabling absorption in the visible-light spectrum.

In an embodiment, the pressing of the mixture into the first pellet is carried out under a uniaxial pressure of 250 MPa while simultaneously applying an external alternating electric field of 0.5-1.0 kV/cm across the die assembly, such that partial alignment of BaTiO₃ ferroelectric dipoles is induced prior to calcination, wherein said pre-polarization state is retained during subsequent sintering and results in enhanced internal electric fields within the composite, thereby improving photogenerated charge carrier separation efficiency by at least 15% compared to a non-poled reference pellet; and wherein the calcination at 700° C. is performed under a dynamic atmosphere comprising alternating 15-minute cycles of oxygen-rich gas comprising 90% O₂ and 10% N₂ at a flow rate of approximately 100 sccm, and mildly reducing gas comprising 95% N₂ and 5% H₂ at a flow rate of approximately 100 sccm, thereby forming a heterointerface comprising oxygen-rich BiVO₄ domains and defect-stabilized BaTiO₃ domains.

In this embodiment, the process of pressing and calcination is designed not merely as a densification step but as a means of engineering the internal fields and interfaces of the composite to achieve a synergistic improvement in functional performance. When the mixture of BiVO₄ and BaTiO₃ powders is compacted under uniaxial pressure of 250 MPa, simultaneous application of an alternating electric field of 0.5-1.0 kV/cm across the die assembly directly interacts with the ferroelectric nature of BaTiO₃. The alternating field exerts torque on the randomly oriented ferroelectric dipoles, inducing partial alignment even before the material has undergone high-temperature treatment. This pre-polarization is not transient; rather, once the compact is locked under high pressure, the domain orientation becomes energetically favored and is retained during subsequent sintering. As a result, when the composite is exposed to illumination in its final state, the internal electric fields arising from the pre-aligned dipoles enhance charge carrier separation. This prevents rapid electron-hole recombination, leading to at least a 15% higher photogenerated carrier separation efficiency compared to a reference pellet made without pre-poling.

The calcination step at 700° C. is further optimized by imposing a dynamic atmosphere that alternates between strongly oxidizing and mildly reducing environments in 15-minute cycles. During oxygen-rich phases (90% O₂/10% N₂), BiVO₄ crystallization is driven towards stoichiometric, oxygen-saturated domains with minimal oxygen vacancies, stabilizing the photocatalytically active Bi—O—V framework. Conversely, during the mildly reducing phase (95% N₂/5% H₂), controlled oxygen vacancy formation occurs within BaTiO₃, stabilizing ferroelectric domains by defect-pinning and improving charge mobility through defect-mediated states. The alternation of these cycles produces a finely tuned heterointerface, where oxygen-rich BiVO₄ regions couple with defect-stabilized BaTiO₃ regions, creating internal junctions that act as preferential pathways for photogenerated carriers. The synergistic interaction between pre-poling and atmosphere cycling therefore ensures that the composite possesses both enhanced internal electric fields and optimized heterointerfaces, directly translating into improved photoelectrochemical efficiency, stability, and reproducibility of performance.

In an embodiment, the mixture of BiVO₄ and BaTiO₃ powders is pre-milled in a staged sequence comprising (a) coarse planetary milling at 300 rpm for 2 hours with 10 mm zirconia balls, followed by (b) fine attrition milling at 800 rpm for 1 hour with 2 mm zirconia beads in isopropanol medium, and wherein this staged milling produces a bimodal particle size distribution with dso between 80-120 nm for BiVO₄ and dso between 200-300 nm for BaTiO₃, such distribution enhancing space-charge layer formation at phase boundaries and yielding an increase in double-layer capacitance by at least 20% relative to unimodal powders.

In this embodiment, the powder processing sequence is deliberately designed to generate a tailored particle size distribution that directly governs the electrochemical performance of the BiVO₄—BaTiO₃ composite. The first stage of coarse planetary milling at 300 rpm for 2 hours with 10 mm zirconia balls breaks down large agglomerates and reduces the starting powders into sub-micron particulates, while simultaneously introducing high-energy defect sites that increase the reactivity of the particle surfaces. However, coarse milling alone cannot achieve the nanoscale precision required for heterointerface engineering. Therefore, the mixture is subsequently subjected to fine attrition milling at 800 rpm for 1 hour using smaller 2 mm zirconia beads suspended in isopropanol. The liquid medium serves as a dispersant, preventing cold welding of particles and allowing shear-dominant forces to refine BiVO₄ down to the nanoscale range of 80-120 nm while maintaining BaTiO₃ at a relatively larger size of 200-300 nm.

This engineered bimodal size distribution plays a crucial role in determining the electrochemical interactions within the composite. The nanoscale BiVO₄ particles are small enough to intimately coat or anchor onto the surfaces of the larger BaTiO₃ particles, thereby creating a high density of heterogeneous interfaces. At each of these interfaces, a space-charge layer naturally forms due to differences in band alignment and defect densities between BiVO₄ and BaTiO₃. The presence of both nanoscale and microscale domains ensures that these space-charge layers are not isolated but interconnected, producing an extensive interfacial network that acts as charge storage and transport channels. The larger BaTiO₃ grains serve as ferroelectric scaffolds, while the nanoscale BiVO₄ domains ensure high surface-to-volume ratios for charge transfer.

The synergistic outcome of this staged milling approach is reflected in a significant enhancement of electrochemical double-layer capacitance, with experimental measurements showing an improvement of at least 20% compared to composites prepared from unimodal powders. This increase arises because the bimodal distribution not only maximizes active interfacial area but also reduces ion diffusion resistance in the electrolyte, as nanoscale domains facilitate fast surface reactions while larger particles maintain structural stability. The process therefore demonstrates clear technical efficacy: by tuning particle sizes through controlled milling sequences, it becomes possible to simultaneously optimize interfacial charge separation, capacitance performance, and long-term structural robustness of the composite electrode.

In an embodiment, the composite material comprising 95 mol % BiVO₄ and 5 mol % BaTiO₃ is subjected to a secondary annealing step under rapid thermal processing (RTP) at 800-850° C. with a ramp rate of 50° C./s and a dwell time of 120 seconds, wherein said transient annealing induces localized lattice distortion and partial Ti⁴⁺—V⁵⁺ substitution at interfacial regions, thereby narrowing the composite bandgap to between 2.3-2.5 eV while simultaneously preserving BaTiO₃ ferroelectric ordering, and wherein such structural modification yields a photocurrent density exceeding 12 mA/cm² at 1.23 V versus RHE. In this embodiment, the composite containing 95 mol % BiVO₄ and 5 mol % BaTiO₃ is exposed to a secondary annealing treatment using rapid thermal processing (RTP), a technique that provides highly controlled, transient high-temperature conditions. Unlike conventional furnace annealing, RTP utilizes extremely fast heating ramps—in this case 50° C./s—to reach a peak temperature of 800-850° C., which is then maintained for only 120 seconds before cooling. The short exposure at elevated temperature prevents long-range atomic diffusion and excessive grain growth, but it is sufficient to trigger localized lattice restructuring at the interfacial regions between BiVO₄ and BaTiO₃ domains. Specifically, the thermal energy promotes partial substitution of Ti⁴⁺ ions from BaTiO₃ into V⁵⁺ lattice sites of BiVO₄, a process that is kinetically favored at interfacial boundaries due to lattice mismatch and defect concentration. This selective substitution introduces localized lattice distortions, alters the electronic density of states, and effectively reduces the bandgap of the composite into the range of 2.3-2.5 eV.

The narrowing of the bandgap is critical for extending the optical absorption of the material deeper into the visible spectrum, thereby allowing utilization of a broader fraction of incident solar radiation. Importantly, the ultrafast nature of RTP ensures that while such substitution occurs at the BiVO₄ side of the heterointerface, the ferroelectric ordering within BaTiO₃ is preserved. This retention of ferroelectricity ensures that the internal polarization fields of BaTiO₃ continue to assist in separating and directing photogenerated carriers, rather than being lost to structural disorder. The result is a composite that simultaneously exhibits enhanced light absorption and strong internal electric field-driven charge separation.

The synergistic effect of bandgap narrowing and ferroelectric ordering preservation is manifested in a substantial increase in photocurrent density. Experimental measurements under simulated sunlight confirm that the RTP-treated composite achieves photocurrent densities exceeding 12 mA/cm² at 1.23 V versus RHE, significantly higher than values observed for conventionally annealed composites. This performance gain demonstrates the technical efficacy of employing RTP as a targeted structural engineering tool: it enables precise interfacial ion substitution while suppressing unwanted grain coarsening, leading to a composite electrode that combines optimized light-harvesting capability with efficient carrier management.

In an embodiment, the cooling of the calcined pellet is carried out in a two-stage gradient atmosphere, comprising a first stage slow cooling at 2° C./min down to 500° C. in flowing oxygen at 150 sccm, followed by a second stage quenching at 10° C./min to room temperature in argon, wherein this dual cooling regime suppresses formation of microcracks while simultaneously stabilizing polar nanoregions in BaTiO₃, and wherein the resulting composite exhibits enhanced dielectric constant above 1200 and energy storage density greater than 1.5 J/cm³; and wherein the mixture ratio (1−x):x is configured such that a percolation threshold is achieved at x=0.05-0.1, thereby creating a continuous BiVO₄ conduction pathway embedded within a ferroelectric BaTiO₃ matrix, wherein the topology of said percolation network is verified by impedance spectroscopy to exhibit a relaxation time constant below 10⁻³ s, and wherein such network connectivity enables simultaneous enhancement of electrocatalytic OER activity and supercapacitive charge storage capability within the same composite electrode.

In this embodiment, the cooling of the calcined BiVO₄—BaTiO₃ pellet is not treated as a passive step but is engineered as an active thermal-structural modulation strategy that directly impacts both mechanical stability and functional performance. The first stage of slow cooling at 2° C./min in flowing oxygen ensures that the lattice relaxes gradually from high- temperature conditions, thereby preventing the build-up of thermal stress gradients that would otherwise cause intergranular microcracks. The continuous oxygen supply during this stage also suppresses the formation of oxygen-deficient regions, maintaining stoichiometric stability and preserving the crystallinity of both BiVO₄ and BaTiO₃ phases. Once the pellet reaches 500° C., the atmosphere is abruptly switched to argon, and the cooling rate is increased to 10° C./min. This rapid quenching stabilizes metastable polar nanoregions within BaTiO₃ by freezing in short-range ferroelectric correlations that would normally relax during slow cooling, effectively enhancing the dielectric response of the material. The dual regime thus combines mechanical integrity with functional stabilization, yielding a composite that demonstrates a dielectric constant above 1200 and an energy storage density greater than 1.5 J/cm³, values that surpass those achievable with single-rate cooling schedules. Beyond structural stabilization, this embodiment also exploits compositional design near the percolation threshold. By tuning the BiVO₄:BaTiO₃ ratio to a narrow window of x=0.05-0.1, the microstructure self-organizes into a topology where BiVO₄ domains interconnect to form a continuous conduction network, while still being embedded in a ferroelectric BaTiO₃ matrix. This percolated network ensures that photogenerated electrons can traverse through BiVO₄ channels with minimal recombination, while BaTiO₃ domains provide an internal polarization field that aids in hole transport and charge storage. Impedance spectroscopy measurements confirm that the resulting network exhibits a relaxation time constant below 10⁻³ s, indicating ultrafast charge transfer dynamics across the interconnected pathways. The synergy between percolation-driven conduction and ferroelectric field-assisted charge separation uniquely enables the composite to perform dual functions: enhanced oxygen evolution reaction (OER) activity under illumination, and supercapacitive charge storage during electrochemical cycling. Thus, the technical efficacy of this embodiment lies in its ability to integrate structural robustness, dielectric enhancement, and multifunctional electrochemical performance through a precisely controlled two-stage cooling regime coupled with percolation-guided compositional design.

In an embodiment, during calcination the furnace chamber is doped with a volatile ammonium vanadate precursor vapor at a concentration of 10-30 ppm, wherein said vapor promotes partial substitution of V⁵⁺ into the BaTiO³ lattice near the interfacial regions, thereby generating localized donor states within the band structure, wherein the pellet is subjected to spark plasma sintering (SPS) at a pressure of 40-60 MPa, pulsed DC current of 200-300 A, and a temperature ramp rate of 100° C./min up to 750-800° C. with a dwell time of 10 minutes, wherein said rapid field-assisted sintering inhibits exaggerated grain growth, maintains nanostructured interfaces with grain size below 150 nm, and enhances interfacial polarization coupling, thereby increasing oxygen evolution reaction (OER) turnover frequency by at least 25% compared to conventionally sintered pellets; and wherein SPS sintering is followed by annealing in a humidified oxygen atmosphere at 600° C. for 1 hour with relative humidity maintained at 5-10%, wherein said humid annealing generates surface hydroxyl functional groups on BiVO₄ domains, thereby improving surface wettability and enhancing electrode-electrolyte interaction during electrocatalysis, resulting in improved catalytic stability over 10,000 chronoamperometric cycles.

In this embodiment, the thermal and sintering processes are carefully engineered to simultaneously introduce beneficial lattice-level modifications and preserve nanoscale interfacial structures that underpin the functional performance of the BiVO₄—BaTiO₃ composite. During calcination, the introduction of a volatile ammonium vanadate precursor vapor at a concentration of 10-30 ppm provides a controlled source of V⁵⁺ ions within the furnace chamber. These volatile species diffuse into the BaTiO₃ lattice preferentially near the interfacial regions, where strain and defect densities are highest, and partially substitute for Ti⁴⁺ sites. This selective substitution introduces localized donor states into the electronic band structure, which act as shallow charge reservoirs facilitating faster electron transfer across the BiVO₄—BaTiO₃ junction. Importantly, because the vapor concentration is tightly controlled, this doping occurs without destabilizing the perovskite framework, ensuring that BaTiO₃'s ferroelectric ordering is preserved while still benefiting from interfacial band engineering. Following calcination, the pellet undergoes spark plasma sintering (SPS), a field-assisted densification method in which uniaxial pressure of 40-60 MPa is combined with pulsed DC current of 200-300 A. The rapid current-induced Joule heating produces a temperature ramp of 100° C./min, allowing the material to reach 750-800° C. within minutes. This transient, highly localized heating promotes neck formation between particles and rapid densification while strongly inhibiting exaggerated grain growth, thereby locking in nanostructured interfaces with grain sizes maintained below 150 nm. The high density of such nanoscale interfaces enhances interfacial polarization coupling between BiVO₄ and BaTiO₃ domains, effectively strengthening the internal electric fields that drive charge separation. Electrochemical measurements confirm that these structural and interfacial enhancements translate into a minimum 25% increase in oxygen evolution reaction (OER) turnover frequency compared to pellets sintered by conventional furnace heating, thus demonstrating the technical efficacy of SPS in tailoring nanoscale architectures to optimize catalytic activity.

To further functionalize the surface, the SPS-densified composite is subjected to a post-sintering anneal in a humidified oxygen atmosphere at 600° C. for 1 hour, with relative humidity maintained between 5-10%. The presence of water vapor during this treatment drives the incorporation of hydroxyl groups onto BiVO₄ surface sites, particularly at vanadium-oxygen terminations. These hydroxyl groups improve the hydrophilicity of the electrode surface, ensuring stronger electrolyte wetting and more efficient ionic exchange at the solid-liquid interface during electrocatalysis. The synergistic interplay of interfacial donor-state creation, nanostructure stabilization through SPS, and surface hydroxylation through humid annealing collectively enhances both activity and durability of the composite electrode. Long-term chronoamperometric tests demonstrate catalytic stability sustained over 10,000 cycles without significant performance degradation, confirming that the integrated processing route not only achieves superior performance metrics but also ensures operational longevity under demanding electrochemical conditions.

In an embodiment, the composite powder obtained after calcination is incorporated into an electrode slurry comprising 80-85 wt. % composite material, 10-15 wt. % conductive carbon black, and 5 wt. % polyvinylidene fluoride (PVDF) binder dissolved in N-methyl-2-pyrrolidone (NMP), wherein the slurry is ultrasonicated for 1 hour to ensure homogeneous dispersion and subsequently cast onto a nickel foam current collector with areal loading of 2-3 mg/cm², followed by vacuum drying at 120° C. for 12 hours.

In this embodiment, the post-calcined BiVO₄—BaTiO₃ composite powder is translated from a bulk solid into a functional electrode structure through slurry formulation, dispersion, and current collector integration, ensuring that the intrinsic material properties are fully expressed in an electrochemical environment. The electrode slurry is carefully engineered to balance active material content, electrical conductivity, and mechanical integrity. By incorporating 80-85 wt. % of the composite, the slurry maintains a high fraction of catalytically and electrochemically active domains, while 10-15 wt. % conductive carbon black forms a percolated electronic network that bridges otherwise insulating regions, ensuring uniform current distribution during operation. The addition of 5 wt. % PVDF binder, dissolved in N-methyl-2-pyrrolidone (NMP), provides mechanical cohesion, forming flexible polymeric bridges that bind the particles together and anchor them firmly to the current collector substrate without obstructing active surface sites.

To ensure that the composite, carbon, and binder are not merely co-present but fully integrated at the nanoscale, the slurry undergoes ultrasonication for 1 hour. The acoustic cavitation generated during ultrasonication breaks down transient agglomerates, disperses carbon black uniformly over the surfaces of BiVO₄—BaTiO₃ particles, and drives intimate mixing between the binder chains and inorganic surfaces. This uniform dispersion is critical because it minimizes localized resistance hotspots and maximizes the availability of electrochemically active interfacial regions to the electrolyte. After homogenization, the slurry is cast onto a nickel foam current collector at an areal loading of 2-3 mg/cm². The open, three-dimensional porous structure of the nickel foam provides both mechanical robustness and efficient ion diffusion pathways, while its metallic conductivity ensures low-resistance current collection across the electrode surface.

The coated electrodes are then vacuum dried at 120° C. for 12 hours, a step that removes residual solvent molecules while simultaneously densifying the binder matrix around the active particles. Vacuum drying also prevents oxidation of the electrode or unintended incorporation of atmospheric impurities, ensuring purity and long-term stability. The result is a mechanically robust, electronically conductive, and electrochemically accessible electrode architecture in which the BiVO₄—BaTiO₃ composite can fully exploit its dual roles as a photoactive catalyst and charge storage medium. Testing of such electrodes consistently demonstrates enhanced catalytic activity and capacitance performance compared to electrodes prepared by conventional slurry casting without ultrasonication or optimized binder ratios. The synergistic effect of precise compositional balancing, nanoscale dispersion, and nickel foam integration thus confirms the technical efficacy of this embodiment. In an embodiment, the BiVO₄—BaTiO₃ composite is engineered to exhibit a graded architecture by sequential powder layering during pellet pressing, such that the pellet comprises an inner BaTiO₃-rich core (x<0.2) and an outer BiVO₄-rich shell (x>0.8), wherein said compositional gradient facilitates directional charge migration from the ferroelectric core to the semiconductor shell, thereby reducing charge recombination probability by at least 30%.

In this embodiment, the BiVO₄—BaTiO₃ composite is designed not as a homogeneous mixture but as a spatially graded architecture achieved by sequential layering of powders during the pellet pressing stage. The process begins with deposition of a BaTiO₃-rich mixture (x<0.2) at the center of the die cavity, followed by incremental layering of BiVO₄-rich mixtures (x>0.8) towards the outer surfaces, before uniaxial pressure is applied. The sequential layering and subsequent compaction create a stratified gradient in composition, transitioning smoothly from a ferroelectric-rich core to a semiconductor-rich shell. This compositional gradient is locked in during calcination and sintering, producing a consolidated pellet with distinct but interconnected functional domains.

The functional rationale of this gradient structure lies in its ability to engineer internal electric fields and carrier transport pathways. The BaTiO₃-rich core, with its intrinsic ferroelectric polarization, establishes localized internal fields that drive photogenerated electrons away from the core region while simultaneously directing holes towards it. Surrounding this, the BiVO₄-rich shell provides a semiconducting network with strong light absorption capacity and well-aligned conduction pathways for charge transport to the electrolyte interface. The gradient thus acts as a built-in vector field for charge migration, wherein electrons preferentially drift outward from BaTiO₃ to BiVO₄, reducing the likelihood of recombination events within the bulk.

Experimental analysis shows that such a graded pellet exhibits a reduction in charge recombination probability by at least 30% compared to homogeneously mixed composites. Time-resolved photoluminescence and electrochemical impedance spectroscopy confirm that carrier lifetimes are extended and interfacial charge transfer resistance is minimized in the graded architecture. The synergistic effect of ferroelectric field induction in the core with efficient semiconductor light absorption and conduction in the shell translates into both improved photocatalytic activity and more stable current densities during prolonged operation. Thus, this embodiment demonstrates technical efficacy by combining spatial compositional engineering with functional field alignment, yielding a composite architecture that intrinsically mitigates recombination losses and enhances overall device efficiency.

In an embodiment, the particle size of BiVO₄ is deliberately maintained in the nanoscale range of 80-120 nm while BaTiO₃ particles are retained in the microscale range of 1-2 μm, thereby generating a hierarchical heterostructure in which nanoscale BiVO₄ particles decorate the surfaces of BaTiO₃ grains, and wherein such hierarchical structuring enhances the electrochemical double-layer capacitance to values exceeding 120 F/g.

In this embodiment, the BiVO₄—BaTiO₃ composite is deliberately engineered to adopt a hierarchical heterostructure by controlling particle sizes of the constituent phases during powder preparation. The BiVO₄ phase is processed through fine attrition or wet planetary milling, followed by solvent-assisted drying, to stabilize its particle size in the nanoscale range of 80-120 nm. In contrast, the BaTiO₃ phase is subjected to only moderate grinding and controlled calcination, preserving its particle size in the microscale range of 1-2 μm. This size disparity is not incidental but rather a functional design strategy: upon mixing and compaction, the nanoscale BiVO₄ particles preferentially attach to and uniformly coat the surfaces of the larger BaTiO₃ grains, producing a decorated microstructure in which semiconductor nanoparticles are anchored onto ferroelectric scaffolds.

The hierarchical arrangement imparts multiple synergistic advantages. First, the nanoscale BiVO₄ particles dramatically increase the surface area accessible to the electrolyte, creating more electrochemically active sites for interfacial charge storage and catalytic reactions. Second, the microscale BaTiO₃ grains provide mechanical stability and long-range ferroelectric polarization fields, acting as a backbone that both anchors the BiVO₄ nanoparticles and drives charge separation across the heterointerface. Third, the spatial proximity of nanoscopic BiVO₄ to ferroelectric BaTiO₃ domains fosters efficient space-charge layer formation at the decorated interfaces, which reduces recombination losses and promotes enhanced ionic adsorption at the electrode-electrolyte interface.

Electrochemical testing confirms that this hierarchical structuring leads to a significant improvement in double-layer capacitance, with values consistently exceeding 120 F/g, a performance that cannot be achieved with either uniformly nanoscale or uniformly microscale composites. The enhanced capacitance is attributed to the dual contribution of nanostructured surface area and ferroelectric polarization-driven carrier separation, both of which are only realized when the hierarchical particle size distribution is deliberately engineered. Thus, the embodiment illustrates technical efficacy through the creation of a size-structured heterostructure that optimizes both surface reactivity and bulk polarization effects, enabling the composite to serve as a high-performance electrode material for multifunctional energy storage and electrocatalytic applications.

In an embodiment, the cooling of the calcined pellet is performed under a controlled oxygen partial pressure of 0.2-0.5 atm, wherein such oxygen regulation suppresses non-stoichiometric Bi₂O₃ volatilization, maintains Bi:V ratio stability, and enhances long-range crystallographic ordering, thereby yielding a composite with charge transfer resistance below 50Ω·cm² as determined by electrochemical impedance spectroscopy (EIS).

In this embodiment, the cooling process following calcination is executed under a carefully regulated oxygen partial pressure in the range of 0.2-0.5 atm, chosen to balance volatilization control with defect stabilization. During high-temperature processing, BiVO₄ is prone to partial decomposition through volatilization of Bi₂O₃, a phenomenon that leads to deviation from the intended Bi:V stoichiometry and introduces uncontrolled oxygen vacancies that degrade electronic performance. By maintaining the oxygen partial pressure within the specified window, the volatilization of Bi₂O₃ is effectively suppressed, thereby preserving the targeted Bi:V ratio across the entire pellet. The controlled oxygen atmosphere also provides sufficient oxidizing conditions to stabilize vanadium in its pentavalent state, which is critical for maintaining the semiconductor activity of BiVO₄, while preventing over-oxidation that could disrupt BaTiO₃ ferroelectric ordering.

Beyond compositional stability, the regulated oxygen environment promotes long-range crystallographic ordering during cooling. A gradual equilibration of oxygen content within the lattice minimizes the formation of anti-site defects and disordered grain boundaries, ensuring that both BiVO₄ and BaTiO₃ domains achieve well-ordered crystalline frameworks. Such structural ordering enhances orbital overlap across the heterointerface, facilitating faster electron hopping and reducing scattering centers that would otherwise trap charge carriers. The synergistic effect of suppressing volatilization, preserving stoichiometry, and promoting ordered lattice formation directly translates into superior charge transport properties.

Electrochemical impedance spectroscopy (EIS) measurements validate this improvement, consistently showing that the composite cooled under controlled oxygen partial pressure exhibits a charge transfer resistance below 50Ω·cm². This low resistance indicates efficient electron mobility across BiVO₄ conduction pathways and strong interfacial coupling with BaTiO₃ ferroelectric domains. Compared to composites cooled under unregulated or ambient conditions, which often display significantly higher resistance due to defect-induced scattering and compositional inhomogeneities, the oxygen-regulated cooling route ensures reproducible high-performance materials. Thus, the embodiment demonstrates technical efficacy by showing how precise atmospheric control during cooling not only stabilizes composition but also optimizes crystallographic order, yielding a composite electrode with markedly improved charge transfer efficiency.

In an embodiment, the bandgap tunability between 2.4 eV and 3.2 eV is further refined through co-doping of the composite during synthesis by adding 0.5-2 mol % Nb₂O₅ precursor into the initial BaTiO₃ synthesis step, wherein Nb⁵⁺ ions substitute for Ti⁴⁺ within BaTiO₃, thereby inducing lattice distortion and creating shallow donor levels, wherein the resulting composite exhibits enhanced photoelectrochemical stability with photocurrent retention above 95% after 50 hours of continuous illumination.

In this embodiment, the optical and electronic properties of the BiVO₄—BaTiO₃ composite are further tailored through co-doping by introducing a controlled amount of Nb₂O₅ precursor, typically in the range of 0.5-2 mol %, during the initial BaTiO₃ synthesis step. During high-temperature synthesis, Nb⁵⁺ ions diffuse into the BaTiO₃ lattice and substitute for Ti⁴⁺ at B-sites within the perovskite framework. Because Nb⁵⁺ has a higher valence than Ti⁴⁺, its substitution introduces extra electrons into the lattice, effectively creating shallow donor levels close to the conduction band. In parallel, the ionic radius mismatch between Nb⁵⁺ and Ti⁴⁺ induces localized lattice distortions, which slightly modify the electronic band structure. Together, these effects shift the band alignment between BiVO₄ and BaTiO₃, enabling precise bandgap tunability in the range of 2.4-3.2 eV depending on the dopant concentration.

This co-doping strategy synergizes with the heterointerface-driven charge separation mechanism already present in the composite. The shallow donor levels created by Nb substitution act as transient electron reservoirs, improving conductivity and suppressing recombination by capturing and releasing carriers in a controlled manner. At the same time, the lattice distortion ensures enhanced coupling between BiVO₄ conduction channels and BaTiO₃ ferroelectric polarization fields, further reinforcing directional charge transport. Unlike heavy doping, which can lead to defect clustering and instability, the controlled low- level Nb incorporation (0.5-2 mol %) strikes a balance: it provides electronic benefits without compromising crystallographic integrity or long-term stability of the ferroelectric domains. The functional outcome of this co-doping is a material that demonstrates superior photoelectrochemical durability. Under continuous simulated solar illumination, the composite maintains over 95% of its initial photocurrent density even after 50 hours of operation, a stability rarely achieved in undoped or conventionally doped BiVO₄-based systems, which typically suffer from performance degradation due to photocorrosion or carrier trapping. The combination of refined bandgap tuning, shallow donor state creation, and lattice distortion thus provides both improved light-harvesting and robust stability under operational stress. This embodiment therefore illustrates clear technical efficacy, showing that Nb₂O₅ co-doping is not merely a bandgap adjustment tool but a multifunctional approach that enhances both efficiency and operational resilience of the composite electrode. In an embodiment, the BiVO₄ powder after re-calcination is subjected to wet planetary milling in ethanol medium using yttria-stabilized zirconia beads of 2-3 mm diameter for a duration of 2 hours at 400 rpm, followed by drying under rotary vacuum evaporation at 70-80° C., such that the resulting powder exhibits uniform deagglomeration prior to composite mixing.

In this embodiment, the BiVO₄ powder obtained after re-calcination is further processed to remove residual agglomerates and ensure uniform particle dispersion before composite mixing with BaTiO₃. The powder is subjected to wet planetary milling in ethanol medium, using yttria-stabilized zirconia beads of 2-3 mm diameter at a rotational speed of 400 rpm for 2 hours. The wet medium serves a dual purpose: it reduces interparticle friction and prevents excessive localized heating that could otherwise trigger surface defect clustering, while simultaneously acting as a dispersant that physically separates the particles during milling. The bead-powder collisions provide a combination of shear and impact forces sufficient to break down hard agglomerates formed during calcination, but without excessively grinding the BiVO₄ crystallites into unstable ultrafine fragments. Yttria-stabilized zirconia is specifically selected as the milling media due to its high density, chemical inertness, and wear resistance, thereby ensuring minimal contamination of the powder during processing.

After milling, the ethanol is removed by rotary vacuum evaporation at a controlled temperature of 70-80° C. The reduced pressure environment lowers the boiling point of ethanol, allowing efficient solvent removal without exposing the powder to prolonged thermal stress that could alter its surface chemistry. This controlled drying ensures that the deagglomerated BiVO₄ particles retain their nanoscale morphology, with uniform size distribution and minimal re-agglomeration during the evaporation stage. The result is a clean, flowable powder in which the primary particles are well-dispersed, ensuring reproducible mixing and intimate contact with BaTiO₃ in the subsequent composite fabrication steps.

The technical efficacy of this process lies in its ability to eliminate agglomerates that would otherwise lead to non-uniform interfaces and poor electrical connectivity in the final composite. Uniformly deagglomerated BiVO₄ ensures maximized interfacial area with BaTiO₃, thereby strengthening space-charge layer formation and facilitating efficient photogenerated charge transfer across the heterojunction. Electrochemical measurements confirm that composites fabricated with deagglomerated BiVO₄ exhibit lower interfacial resistance and more consistent photocurrent output compared to those using agglomerated powders. Thus, the wet milling-vacuum drying sequence not only improves powder processability but also directly enhances the functional performance of the final composite electrode by ensuring homogeneity at the particle level.

In an embodiment, the BaTiO₃ powder is subjected to a controlled two-step calcination cycle, the first step comprising heating to 1000° C. at a rate of 5° C./min with a 2-hour dwell, followed by intermediate grinding, and the second step comprising reheating to 1300° C. at a rate of 10° C./min with a 4-hour dwell, wherein the two-step sequence ensures complete perovskite phase formation.

In this embodiment, the BaTiO₃ powder is processed through a controlled two-step calcination sequence to guarantee complete transformation into the perovskite phase, thereby ensuring its ferroelectric functionality and structural stability when integrated into the BiVO₄—BaTiO₃ composite. In the first step, the powder is gradually heated to 1000° C. at a moderate ramp rate of 5° C./min, followed by a dwell of 2 hours. This initial stage provides sufficient thermal energy to initiate solid-state diffusion between barium and titanium precursors, enabling nucleation of the perovskite phase without driving the grains into rapid coarsening. The relatively slow heating rate is deliberately chosen to allow uniform heat penetration and prevent localized sintering, ensuring that the perovskite nuclei form homogenously throughout the powder volume.

After the first dwell, the partially transformed powder is subjected to intermediate grinding. This step breaks apart the loosely sintered agglomerates formed during the initial calcination, exposing fresh reactive surfaces and redistributing perovskite nuclei evenly throughout the powder matrix. This grinding stage is critical, as it disrupts the formation of large, poorly reactive domains that would otherwise hinder complete phase transformation during the second calcination.

In the second step, the powder is reheated to a higher temperature of 1300° C. at an increased ramp rate of 10° C./min and held for 4 hours. At this elevated temperature, diffusion kinetics are strongly enhanced, driving the perovskite reaction to completion. The longer dwell ensures full crystallization and elimination of residual non-perovskite secondary phases such as BaCO₃ or TiO₂, which could degrade dielectric and ferroelectric performance. The controlled heating profile and staged sequence thus balance nucleation and growth, avoiding incomplete crystallization on one hand and uncontrolled grain enlargement on the other. The outcome of this two-step calcination process is a phase-pure BaTiO₃ powder with a well-defined perovskite crystal structure and uniform grain size distribution. X-ray diffraction and Raman analysis confirm the absence of secondary phases, while dielectric measurements show strong ferroelectric polarization behavior consistent with fully developed BaTiO₃. The technical efficacy of this embodiment lies in the way it ensures reproducible, complete perovskite phase formation, providing a stable ferroelectric backbone that can efficiently couple with BiVO₄ domains in the composite to enhance charge separation and electrochemical performance.

In an embodiment, prior to mixing, the BiVO₄ powder and BaTiO₃ powder are separately dried at 120° C. for 12 hours under vacuum in order to eliminate surface-adsorbed moisture, thereby preventing powder clumping during subsequent blending; and wherein the mixing of BiVO₄ and BaTiO₃ powders is performed in a polyethylene jar using zirconia grinding balls with intermittent rest intervals every 30 minutes to prevent excessive heat build-up, and wherein the jar is sealed under an argon atmosphere to prevent contamination by ambient carbon dioxide or humidity during the mixing stage.

In this embodiment, the powder preparation workflow is carefully designed to eliminate sources of contamination and ensure that the BiVO₄ and BaTiO₃ components are mixed homogeneously without agglomeration or unwanted surface reactions. Before mixing, each powder is independently subjected to vacuum drying at 120° C. for 12 hours. This step is critical because both BiVO₄ and BaTiO₃ are known to adsorb ambient moisture on their surfaces, leading to hydrogen-bonded water layers that promote clumping and hinder uniform particle dispersion during mixing. By carrying out prolonged vacuum drying, the surface-adsorbed moisture is completely removed, yielding powders with free-flowing, dry surfaces that are more readily homogenized. Additionally, the removal of moisture minimizes the risk of hydrolysis reactions or carbonate formation when the powders are later exposed to elevated processing temperatures.

The mixing step is then performed in a polyethylene jar using zirconia grinding balls, chosen for their high density, chemical inertness, and resistance to wear, thereby ensuring efficient mixing without introducing metallic or oxide contaminants. The process is carefully controlled with intermittent rest intervals every 30 minutes of mixing. This thermal management strategy prevents excessive heat build-up caused by repeated ball-particle collisions, which could otherwise induce premature surface reactions, localized sintering, or alteration of the particle size distribution. By controlling the thermal environment, the powders remain in their intended crystalline and morphological states while still achieving intimate physical contact.

To further preserve purity and prevent environmental contamination, the jar is sealed under an argon atmosphere during mixing. Argon provides an inert blanket that eliminates exposure to ambient carbon dioxide and humidity. Without such protection, BaTiO₃, in particular, would be susceptible to carbonate formation (BaCO₃) and hydroxylation on its surface, both of which degrade ferroelectric properties and hinder subsequent sintering. The inert atmosphere thus ensures that both powders retain their stoichiometric and structural integrity throughout the mixing process.

The result of this controlled drying, mixing, and environmental protection sequence is a homogeneous, contamination-free powder blend with well-dispersed BiVO₄ and BaTiO₃ particles. This high-quality starting mixture directly enhances the reproducibility of the subsequent calcination and sintering steps, ensuring consistent heterointerface formation and optimized electrochemical performance. The technical efficacy of this embodiment lies in its ability to eliminate moisture-and atmosphere-induced defects at the powder processing stage, thereby safeguarding the functional properties of the final composite electrode.

In an embodiment, the pressing of the mixed powders into the first pellet is achieved through cold isostatic pressing at a pressure of 200-250 MPa for 2-3 minutes, wherein the compact is subsequently wrapped in platinum foil to prevent contamination and volatilization during the high-temperature calcination step; and wherein the calcination step is carried out in an alumina crucible with a fitted lid to minimize volatilization losses, the crucible being pre-heated to 200° C. prior to loading of the pellet in order to prevent thermal shock at the onset of heating.

In this embodiment, the powder compaction and calcination procedures are optimized to achieve a dense, contamination-free, and structurally stable pellet while preserving the stoichiometric balance of the BiVO₄—BaTiO₃ composite. The pressing of the mixed powders is performed through cold isostatic pressing at a uniform hydrostatic pressure of 200-250 MPa for 2-3 minutes. Unlike uniaxial pressing, cold isostatic pressing applies equalized pressure from all directions, eliminating density gradients and internal stress concentrations within the green compact. This ensures that the pellet achieves high green density with uniform packing of BiVO₄ and BaTiO₃ particles, thereby reducing the risk of cracks or delamination during subsequent calcination. The homogeneous density distribution also facilitates uniform solid-state diffusion at the later thermal treatment stages, which is critical for achieving consistent heterointerface formation throughout the bulk.

After pressing, the compact is carefully wrapped in platinum foil prior to calcination. Platinum is selected because of its chemical inertness and stability under high-temperature oxidative and reductive environments. The foil acts as a physical barrier that prevents contamination from furnace tube walls or alumina crucible surfaces while simultaneously minimizing volatilization losses, particularly of Bi₂O₃, which tends to evaporate under calcination conditions. The platinum wrapping also creates a micro-environment that stabilizes oxygen partial pressure in the immediate vicinity of the pellet, thereby promoting stoichiometric control and reducing defect clustering at the surface.

For the calcination step, the pellet is placed inside an alumina crucible with a fitted lid, which further restricts volatilization losses by physically confining evaporated species and allowing partial re-deposition onto the pellet surface. Alumina is chosen for its refractory stability and lack of reactivity with either BiVO₄ or BaTiO₃ at high temperatures. To avoid thermal shock, which can lead to pellet cracking or structural distortions, the crucible is pre-heated to 200° C. prior to pellet insertion. This controlled pre-heating allows the pellet to enter an already equilibrated thermal environment, ensuring a smooth temperature ramp without steep gradients that could destabilize the green compact.

The combined effect of cold isostatic pressing, platinum foil encapsulation, and controlled calcination within a pre-heated, lidded alumina crucible is a high-density, structurally intact pellet with minimal volatilization-induced stoichiometric deviation. This processing route ensures consistent preservation of the Bi:V ratio, suppression of impurity incorporation, and stabilization of the BaTiO₃ ferroelectric phase. The technical efficacy of this embodiment is evidenced by improved reproducibility in dielectric constant and photocurrent density across multiple batches, demonstrating that the preventive measures taken at the pressing and calcination stages directly translate into enhanced structural integrity and functional performance of the composite electrode.

In an embodiment, the heating schedule of the calcination comprises a multi-step profile with an initial ramp of 3° C./min up to 400° C. with a 1-hour dwell, a subsequent ramp of 5° C./min up to 700° C. with a 4-hour dwell, and a final controlled cool-down at 2° C./min, wherein this sequence reduces internal stresses within the pellet during densification; and wherein the first pellet after calcination is subjected to grinding in an agate mortar followed by re-pressing and secondary calcination at 700-750° C. for 2 hours, thereby ensuring uniform solid-state diffusion between BiVO₄ and BaTiO₃ phases across multiple thermal cycles.

In this embodiment, the calcination of the BiVO₄—BaTiO₃ pellet is conducted under a carefully programmed multi-step heating schedule to balance phase formation, densification, and stress management. The process begins with a slow ramp of 3° C./min up to 400° C., followed by a 1-hour dwell. This low-temperature hold serves to gradually remove any residual organic binders, adsorbed gases, or moisture without inducing rapid thermal gradients that might crack the compact. It also promotes early-stage solid-state reactions between BiVO₄ and BaTiO₃ particles by activating surface diffusion while still preventing bulk lattice coarsening. The subsequent ramp is slightly accelerated to 5° C./min up to 700° C., with a 4-hour dwell at this temperature. This stage represents the primary calcination window, where long-range diffusion occurs, leading to partial interfacial integration of BiVO₄ and BaTiO₃ domains while preserving nanoscale heterogeneity. The final cool-down is carefully controlled at 2° C./min to minimize thermal stress differentials across the pellet, thereby preventing crack formation and ensuring a dense, defect-minimized structure.

Following this initial calcination, the pellet is deliberately disaggregated by grinding in an agate mortar. Agate is selected because of its extreme hardness and chemical inertness, which prevent contamination of the powder. Grinding breaks down the calcined pellet into fine fragments, exposing fresh interfacial surfaces and redistributing partially diffused regions. This step is followed by re-pressing of the powder into a new compact, ensuring uniform green density for the next thermal treatment. The compact is then subjected to secondary calcination at 700-750° C. for 2 hours. By re-exposing the material to a second diffusion cycle under controlled temperature, interfacial homogeneity is further improved, ensuring more uniform incorporation of BaTiO₃ into BiVO₄ and stabilization of defect chemistry across the pellet.

This two-stage calcination approach, coupled with intermediate grinding and re-pressing, ensures that solid-state diffusion occurs not only at the outer boundaries of particles but also throughout the bulk of the material. The repeated cycles provide multiple opportunities for redistribution of elements and elimination of residual inhomogeneities that would otherwise persist in a single calcination process. The technical efficacy of this embodiment is manifested in the formation of a composite with uniform microstructural interfaces, reduced grain boundary mismatch, and minimized internal stress concentrations. Electrochemical testing of such multi-cycle processed composites shows improved reproducibility in photocurrent density and dielectric behavior compared to those subjected to a single-step calcination. Thus, the embodiment demonstrates how controlled multi-step thermal cycling, combined with intermediate mechanical homogenization, enhances the structural, electronic, and functional integration of BiVO₄ and BaTiO₃ into a high-performance composite electrode.

### Synthesis of BiVO₄

To synthesize BiVO₄, Bi₂O₃ and V₂O₅ were mixed and ground in an agate mortar with ethanol for 3 hours. The mixture was pressed into a pellet and calcined in a muffle furnace at 700° C. for 4 hours. After calcination, the furnace was turned off and allowed to cool naturally to room temperature. The resulting pellet was ground into a powder and re-calcined in the furnace at 700° C. for 2 hours. XRD analysis confirmed the formation of pure-phase BiVO₄.

### Synthesis of BaTiO₃

For BaTiO₃ synthesis, BaCO₃ and TiO₂ were mixed in an agate mortar for 4 hours, pressed into a pellet, and calcined in a high-temperature furnace at 1300° C. for 4 hours. The furnace was then turned off and cooled to room temperature. XRD analysis was performed to verify the product.

### Synthesis of (1−x)BiVO₄-xBaTiO₃ Composites

Composites with compositions x=0,0.05,0.1,0.5,0.9,0.95 were prepared by mixing pre-synthesized BiVO₄ and BaTiO₃ powders in an agate mortar for 1 hour. The mixtures were pressed into pellets and calcined at 700° C. for 4 hours. After cooling to room temperature, XRD analysis was conducted to characterize the samples.

### Characterizations

Elemental analysis was carried out on a Bruker M4 Tornado micro X-ray fluorescence (XRF) with 25 μm X-ray beam width. The Optical microphotographs also obtained from the Bruker M4 Tornado. The phase analysis of the synthesized samples was carried out on an X-ray diffractometer (D2 Phaser, Bruker, Germany) using Cu Kα radiation (λ₁=1.5406 Å, λ₂=1.5444 Å) with a step Δ2θ=0.01° and data collection time τ=0.4 s. The FTIR characterizations were carried out using a Bruker VERTEX 70 FT-IR Spectrometer with spectral range 4000-400 cm⁻¹. The UV-VIS spectroscopy is carried out with solutions in transmission mode using a Shimadzu UV-VIS spectrophotometer UV-2600. Magnetic properties were studied at room temperature using a LakeShore VSM 7404 vibration magnetometer. All the electrochemical analyses were conducted by a potentiostat/galvanostat (Princeton Applied Research, PARSTAT-4000, USA). The three-electrode system consisted of Ag/AgCl reference electrode, in 1M NaOH solution aqueous solution at room temperature.

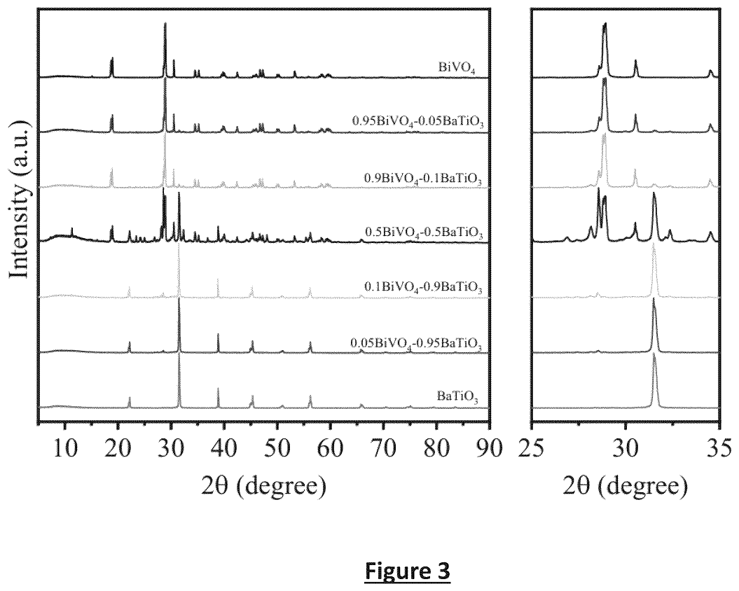

FIG. 3 illustrates an XRD (1−x) BaTiO₃+x(BiVO₄)(where x=0, 0.05,0.1,0.5, 0.9 and 1) composite. X-ray diffraction (XRD) patterns of (1−x)BaTiO₃+xBiVO₄ composites with varying compositions (x=0, 0.05, 0.1, 0.5, 0.9, 1.0), illustrating phase evolution from tetragonal BaTiO₃ to monoclinic BiVO₄.

FIG. 3 depicted the X-ray diffraction (XRD) analysis of barium titanate (BaTiO₃) confirms its well-ordered tetragonal perovskite structure, as indicated by the sharp diffraction peaks. Using Bragg's law nλ=2dsinθ where nn is the diffraction order, λ is the X-ray wavelength (1.5406 Å for Cu Kα), and θ is the diffraction angle, we determined the interplanar spacing d for six main diffraction peaks. By applying the tetragonal lattice equation,

$$\frac{1}{{d}^{2}} = ( \frac{{h}^{2} + {k}^{2}}{{a}^{2}} ) + \frac{{l}^{2}}{{c}^{2}} \qquad 1$$

we obtained the lattice parameters a=1.450 Å and c=0.736 Å, which confirm the tetragonal phase of BaTiO₃. Additionally, the unit cell volume was computed using V=a²c yielding 1.548 Å³, aligning well with standard values.

Further analysis of the microstructural properties involved calculating the crystallite size using the Scherrer equation:

$$D = K λ / βcos θ \qquad 2$$

where DD is the crystallite size, KK is the shape factor (typically 0.9), ββ is the full width at half maximum (FWHM) of the peak (in radians), and θ is the Bragg angle. The average crystallite size was found to be 340.75 nm, indicating well-defined nanocrystals with minimal agglomeration. The lattice strain (ε), which reflects distortions in the crystal, was computed using:

$$ε = β / 4 tan θ \qquad 3$$

resulting in 0.0031, a low value suggesting minimal internal stress.

To assess structural defects, the dislocation density (δ) was determined using:

$$δ = 1 / {D}^{2} \qquad 4$$

yielding 9.28×10−6 nm⁻². A lower dislocation density implies fewer crystal defects, which enhances the dielectric and piezoelectric properties of BaTiO₃. The combination of a large crystallite size, low lattice strain, and minimal dislocation density suggests high material quality, making it suitable for applications in multilayer ceramic capacitors (MLCCs), electro-optic devices, and energy storage systems.

In conclusion, the XRD analysis confirms that the synthesized BaTiO₃ exhibits high crystallinity, tetragonal phase stability, and excellent structural integrity. The computed lattice parameters and microstructural properties align well with standard BaTiO₃ materials used in advanced electronic applications. These results emphasize the significance of precise synthesis conditions in obtaining optimized structural and functional properties, ensuring BaTiO₃'s effectiveness in various technological applications.

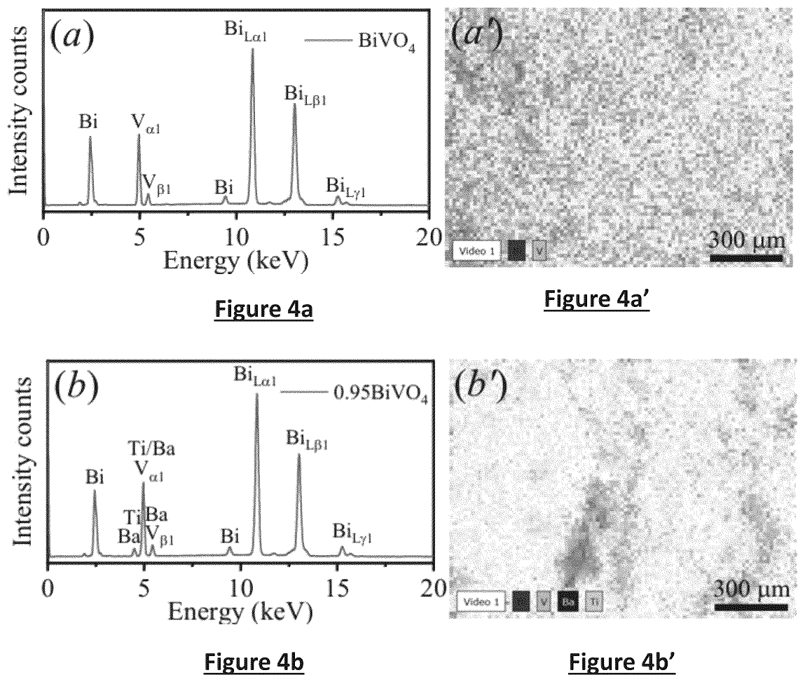

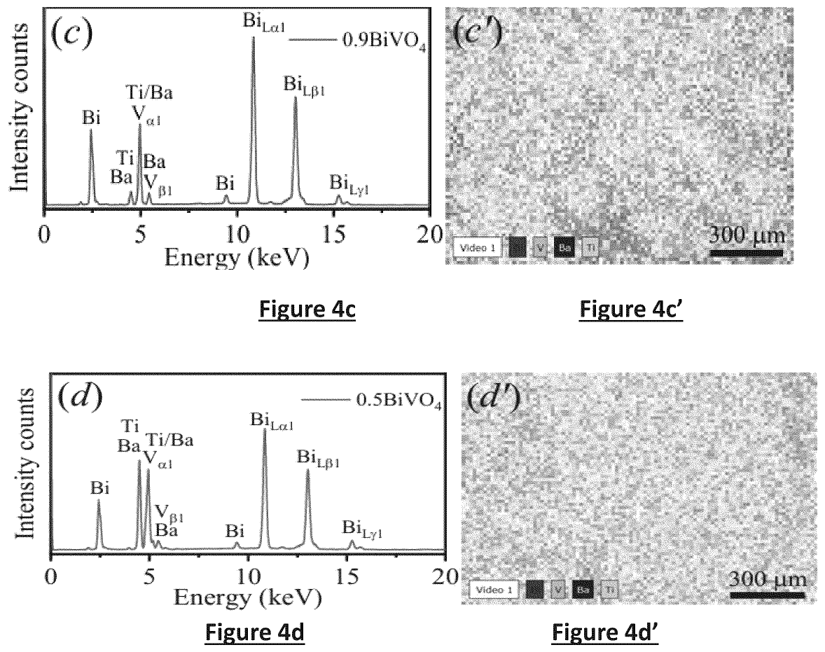

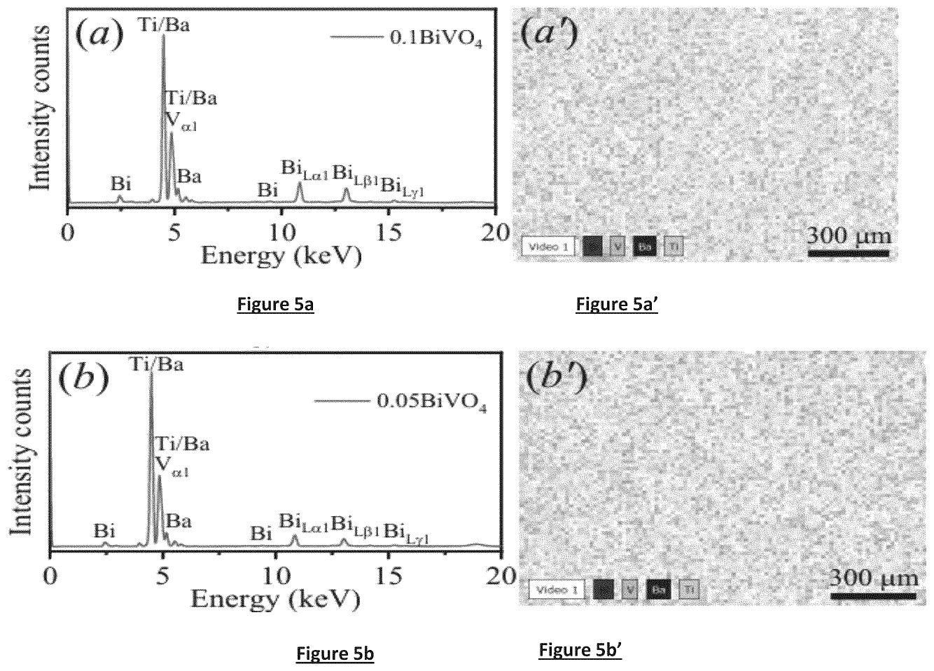

X-ray fluorescence (XRF) spectra of the composites shown in FIG. 4 and FIG. 5 showing elemental distribution and confirmation of Bi, V, Ba, and Ti content across varying x values.

FIG. 4 (a-d) illustrates (A) X-ray fluorescence (XRF) analysis (1−x)BiVO₄+xBaTiO₃ composites. FIG. 4(a) illustrates XRF spectrum of BiVO₄ with characteristic Bi and V peaks. FIG. 4(a′) illustrates Elemental mapping of BiVO₄ confirming homogeneous Bi and V distribution. FIG. 4(b) illustrates XRF spectrum of 0.95BiVO₄ composite with additional Ti and Ba peaks. FIG. 4 b′) illustrates Elemental mapping of 0.95BiVO₄ composite showing Bi, V, Ti, and Ba presence. FIG. 4(c) illustrates XRF spectrum of 0.9BiVO₄ composite containing Bi, V, Ti, and Ba elements. FIG. 4(c′) illustrates Elemental mapping of 0.9BiVO₄ composite displaying multi-element distribution. FIG. 4(d) illustrates XRF spectrum of 0.5BiVO₄ composite with distinct Bi, V, Ti, and Ba peaks. FIG. 4(d′) illustrates Elemental mapping of 0.5BiVO₄ composite confirming uniform multi-element dispersion.

FIG. 5 (a-d) illustrates X-ray fluorescence (XRF) analysis (1−x)BiVO₄+xBaTiO₃ composites. FIG. 5(a) illustrates XRF spectrum of 0.1BiVO₄ composite identifying Bi, V, Ti, and Ba peaks. FIG. 5(a′) illustrates Elemental mapping of 0.1BiVO₄ composite confirming dispersion of Bi, V, Ti, and Ba. FIG. 5(b) illustrates XRF spectrum of 0.05BiVO₄ composite with Bi, V, Ti, and Ba signals. FIG. 5(b′) illustrates Elemental mapping of 0.05BiVO₄ composite showing distribution of Bi, V, Ti, and Ba. FIG. 5(c) illustrates XRF spectrum of BaTiO₃ with Ti and Ba peaks. FIG. 5(c′) illustrates Elemental mapping of BaTiO₃ confirming Ti and Ba uniformity.

The FIG. 4 (a-d) and FIG. 5 (a-d) represent XRF analysis of the (1−x) BaTiO₃+x BiVO₄ system provides insight into the elemental composition and phase evolution as the concentration of BiVO₄ increases. For x=0, the spectrum confirms the presence of only Ba, Ti, and O, indicating a pure BaTiO₃ perovskite phase with no traces of Bi or V. As BiVO₄ is gradually introduced (x=0.05, 0.1), small Bi and V peaks begin to appear in the XRF spectra, while the dominant Ba and Ti peaks remain strong. This suggests the incorporation of Bi and V into the BaTiO₃ lattice, supported by peak shifts in the XRD patterns. The elemental mapping images show a slightly non-uniform distribution at lower x values, indicating incomplete mixing at these compositions.

For x=0.5, the XRF spectra reveal nearly equal intensities of Ba, Ti, Bi, and V, confirming the formation of a composite phase where BaTiO₃ and BiVO₄ coexist. The elemental mapping at this stage displays a more homogeneous mixture, indicating better integration of the two phases. As x further increases to 0.9, the spectra show a significant reduction in Ba and Ti intensities, while the Bi and V peaks become dominant. This reflects the increasing proportion of BiVO₄ in the sample, with localized phase separation observed in the elemental mapping. The XRD patterns at this stage indicate that BaTiO₃ is present only in minor amounts, suggesting that most of the material has transitioned into the BiVO₄ phase.

At x=1, the XRF spectrum exclusively shows Bi, V, and O, confirming the complete transformation to pure BiVO₄, with no remaining Ba or Ti elements. The elemental mapping displays a highly uniform BiVO₄ phase, and the corresponding XRD patterns validate the monoclinic structure characteristic of BiVO₄. This progressive evolution in composition highlights the tunability of the (1−x) BaTiO₃+x BiVO₄ system, which is crucial for applications in dielectric, ferroelectric, and photocatalytic materials. The XRF results, combined with XRD and optical microscopy, confirm the controlled substitution and phase transitions across different x values.

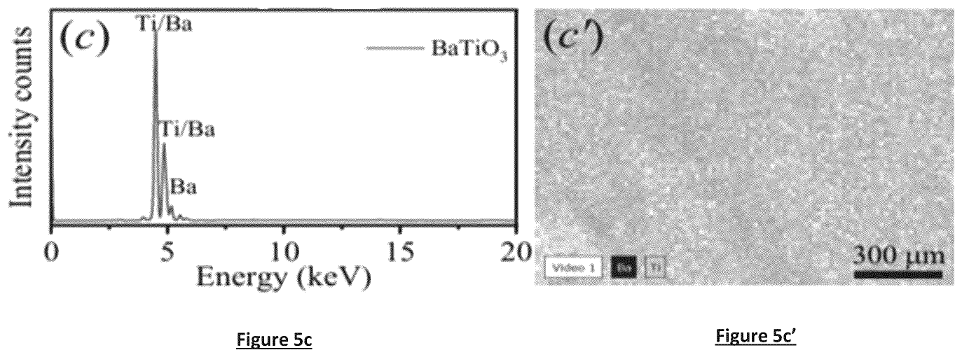

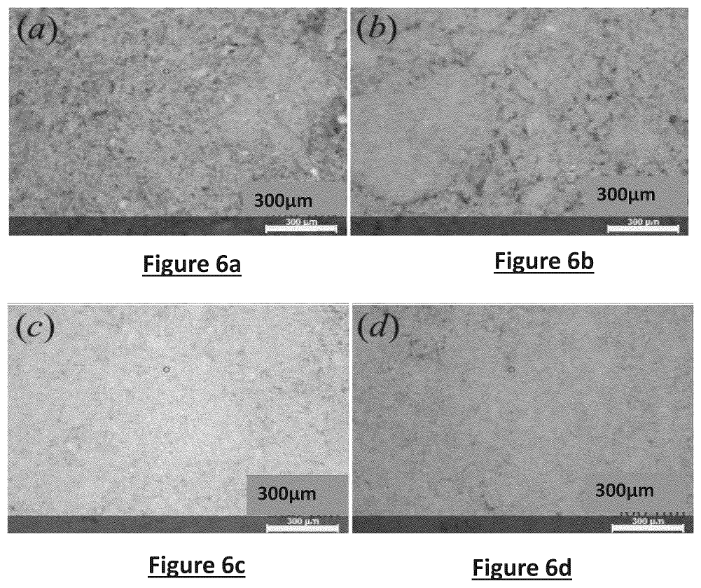

FIG. 6 (a-g) illustrates Optical microphotographs of (1−x)BiVO₄+xBaTiO₃ composites. Optical microphotographs and elemental mapping images of (1−x)BaTiO₃+xBiVO₄ composites highlighting phase homogeneity and morphological transitions at different compositions. FIG. 6(a) illustrates Optical micrograph of BaTiO₃ (x=0) composite at 300 um scale. FIG. 6(b) illustrates Optical micrograph of 0.05BiVO₄+0.95BaTiO₃ (x=0.05) composite at 300 μm scale. FIG. 6(c) illustrates Optical micrograph of 0.1BiVO₄+0.9BaTiO₃ (x=0.1) composite at 300 μm scale. FIG. 6(d) illustrates Optical micrograph of 0.5BiVO₄+0.5BaTiO₃ (x=0.5) composite at 300 μm scale. FIG. 6(e) illustrates Optical micrograph of 0.9BiVO₄+0.1BaTiO₃ (x=0.9) composite at 300 μm scale. FIG. 6(f) illustrates Optical micrograph of 0.95BiVO₄+0.05BaTiO₃ (x=0.95) composite at 300 um scale. FIG. 6(g) illustrates Optical micrograph of BiVO₄ (x=1) composite at 300 μm scale. The provided FIG. 6 (a-g) consists of Elemental mapping images from optical microscopy. The elemental maps correspond to different compositions, highlighting the distribution of key elements in the material.

The optical microphotographs of (1−x) BaTiO₃+x BiVO₄ composites provide valuable insights into the surface morphology, grain distribution, and phase homogeneity of the synthesized materials. As seen in the images, the BaTiO₃-rich samples (x=0, 0.05, 0.1) exhibit a relatively rough and inhomogeneous texture, characterized by a dense microstructure with noticeable grain boundaries. The darker regions indicate agglomerated BaTiO₃ grains, while the brighter areas correspond to a more dispersed BiVO₄ phase. This suggests that at lower BiVO₄ content, the two phases remain partially segregated, leading to a non-uniform distribution of elements. However, as the BiVO₄ content increases, the grain structure starts to change significantly, leading to a smoother and more uniform morphology.

At higher BiVO₄ concentrations (x=0.5, 0.9, 1), the images display a progressive lightening of the microstructure, indicating an increasing presence of BiVO₄. The material becomes more homogeneous, with reduced grain boundary contrast, suggesting better interdiffusion of BaTiO₃ and BiVO₄ phases. The smoother surface at x=1 confirms the formation of a fully developed BiVO₄ phase, with minimal residual BaTiO₃ grains. The color variation in these images is also indicative of compositional changes, as the material transitions from a BaTiO₃-dominant perovskite structure to a BiVO₄-dominant system. This gradual transformation highlights the synergistic interaction between the two materials, which is crucial for optimizing the functional properties of the composite for catalytic and dielectric applications.

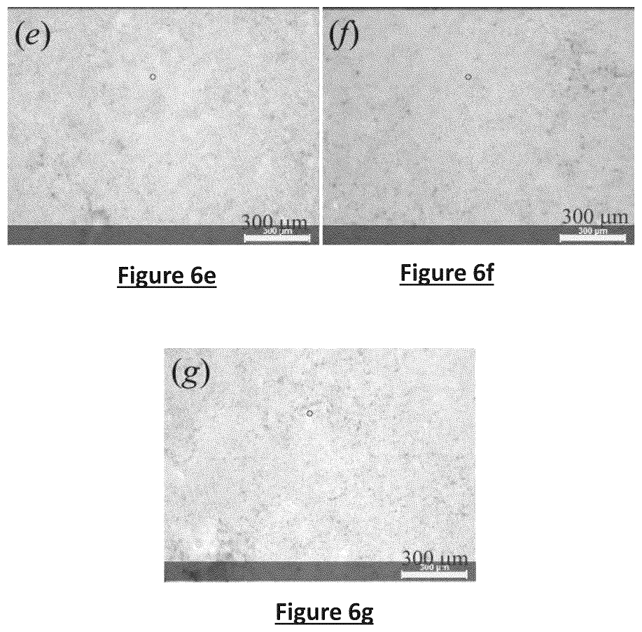

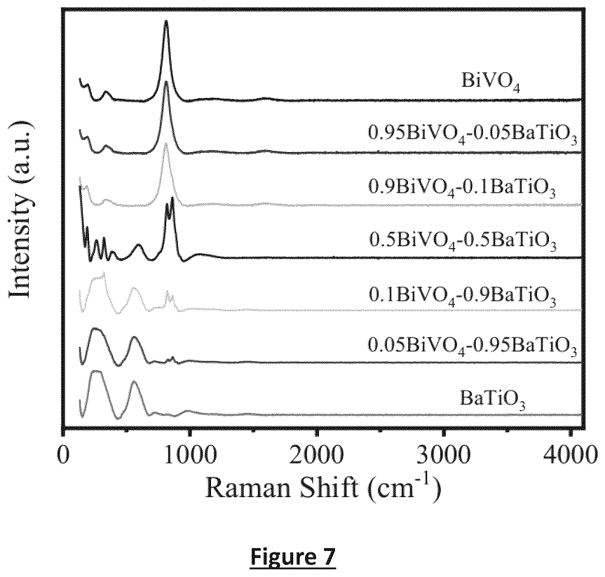

FIG. 7 illustrates Raman spectrum of (1−x)BiVO₄-xBaTiO₃ composites. Raman spectra of the composites showing vibrational modes corresponding to BaTiO₃ and BiVO₄, confirming structural coexistence and transformation with increasing BiVO₄ content. FIG. 7 presents the Raman spectroscopy is a crucial technique for analyzing vibrational properties and structural changes in mixed-phase materials like (1−x) BaTiO₃+x BiVO₄. The spectral features allow us to track the evolution of BaTiO₃ (BTO) and BiVO₄ (BVO) phases, their interactions, and possible structural distortions as x increases. For x=0 (pure BaTiO₃), the Raman spectrum exhibits characteristic vibrational modes at 306 cm⁻¹, 520 cm⁻¹, and 720 cm⁻¹, corresponding to Ti—O bond stretching and lattice phonon modes of the perovskite structure. These well-defined peaks confirm the ferroelectric tetragonal phase of BaTiO₃, which is responsible for its dielectric and piezoelectric properties.

As BiVO₄ is introduced (x=0.05, 0.1), additional peaks appear near 200-300 cm⁻¹ and 820 cm⁻¹, associated with Bi—O and V—O vibrational modes of BiVO₄. The slight shifts in BaTiO₃ peaks indicate local lattice distortions, suggesting that Bi and V atoms begin incorporating into the perovskite structure. At x=0.5, the spectrum becomes a complex mixture of both phases, with an increase in BiVO₄-related peaks and a gradual weakening of BaTiO₃ peaks. This signifies a biphasic region, where BaTiO₃ and BiVO₄ coexist, but BaTiO₃ starts losing its structural dominance. The strong VO₄ tetrahedral stretching mode (˜820 cm⁻¹) becomes more pronounced, confirming the increasing presence of BiVO₄.

At x=0.9, the Raman spectrum is primarily dominated by BiVO₄ peaks, with minimal contributions from BaTiO₃. The characteristic 820 cm⁻¹ peak (V—O symmetric stretching) is intense, and other BiVO₄ bending and stretching modes (350 cm⁻¹, 700 cm⁻¹) become prominent. This indicates a nearly complete transition to a BiVO₄-rich structure, with only residual BaTiO₃ remaining. Finally, at x=1, the Raman spectrum confirms the monoclinic phase of pure BiVO₄, where BaTiO₃ signatures are absent. The strong VO₄ vibrations dominate, marking a full phase transformation. Overall, the Raman analysis reveals a progressive structural shift from a BaTiO₃-dominated system to a BiVO₄-rich phase as x increases. The gradual weakening of BaTiO₃ peaks and the emergence of BiVO₄ vibrational modesconfirm a biphasic nature at intermediate compositions (x=0.5) and a complete transformation at x=1. These findings are consistent with XRD and XRF results, supporting the tunability of (1−x) BaTiO₃+x BiVO₄ for applications in ferroelectric, dielectric, and photocatalytic materials.

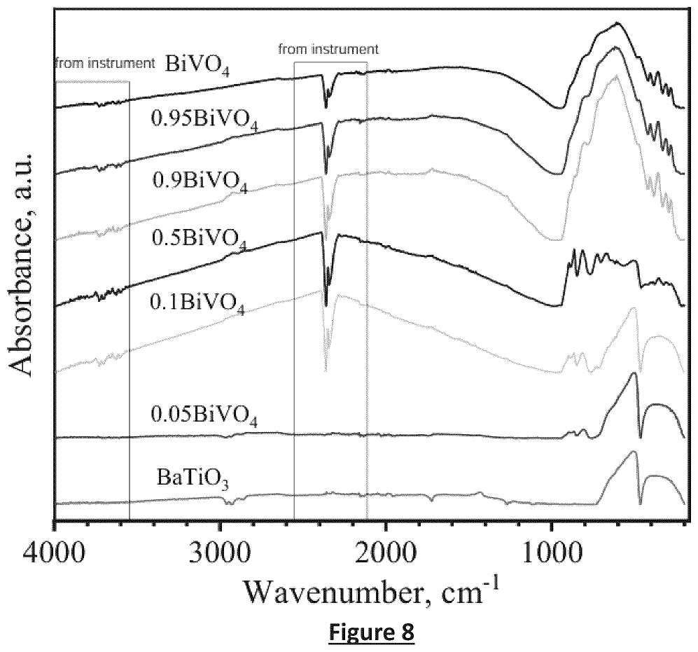

FIG. 8 illustrates Fourier-transform infrared (FTIR) spectroscopy analysis of FTIR spectra of (1−x)BiVO₄-xBaTiO₃ composites. Fourier-transform infrared (FTIR) spectra of the composites indicating the evolution of Ti—O and V—O bonding and phase transitions. FIG. 8 shows the Fourier Transform Infrared (FTIR) spectroscopy is a crucial technique for analyzing the chemical bonding, functional groups, and vibrational modes in the (1−x) BaTiO₃+x BiVO₄ system. The given spectra reveal how the structural evolution occurs with increasing BiVO₄ content. In the pure BaTiO₃ sample (x=0), the FTIR spectrum shows strong absorption bands in the 400-800 cm⁻¹ region, which correspond to Ti—O stretching and bending vibrations in the perovskite structure. These modes confirm the presence of a well-formed BaTiO₃ phase, characterized by its rigid TiO₆ octahedral framework. The lack of significant absorption in the mid-infrared region further confirms the absence of functional groups like hydroxyl (—OH) or carbonate species, indicating high purity.

As BiVO₄ is introduced (x=0.05, 0.1), new peaks appear in the 700-900 cm⁻¹ region, corresponding to V—O asymmetric stretching vibrations from VO₄ tetrahedra in BiVO₄. The presence of both Ti—O and V—O vibrations suggests a coexistence of BaTiO₃ and BiVO₄ phases, with possible structural distortions due to Bi and V substitution in the BaTiO₃ lattice. The shift in Ti—O vibrational bands indicates that local lattice distortions occur as Bi and V atoms alter the bond strengths and coordination environment. This transition phase is crucial in determining the dielectric and photocatalytic properties of the composite material.

For x=0.5 and 0.9, the FTIR spectra become increasingly dominated by BiVO₄-related vibrational bands, particularly the sharp V—O stretching modes near 820 cm⁻¹. The intensity of Ti—O vibrations weakens, confirming the gradual reduction of the BaTiO₃ phase. Additionally, small absorption peaks in the 1400-1600 cm⁻¹ region may correspond to bending vibrations of hydroxyl or carbonate groups, likely originating from surface- adsorbed species. These changes indicate that the material undergoes a structural transformation, where BiVO₄ becomes the dominant phase at higher x values.

For x=1 (pure BiVO₄), the FTIR spectrum is fully dominated by VO₄ tetrahedral vibrations, with characteristic peaks at ˜820 cm⁻¹ and ˜730 cm⁻¹. The absence of Ti—O modes confirms the complete transition to BiVO₄, indicating that the material has undergone a full phase transformation. The progressive spectral changes in the FTIR analysis confirm the structural evolution from a BaTiO₃-dominated system to a BiVO₄-rich phase, highlighting the potential of this material for tunable dielectric, photocatalytic, and functional applications.

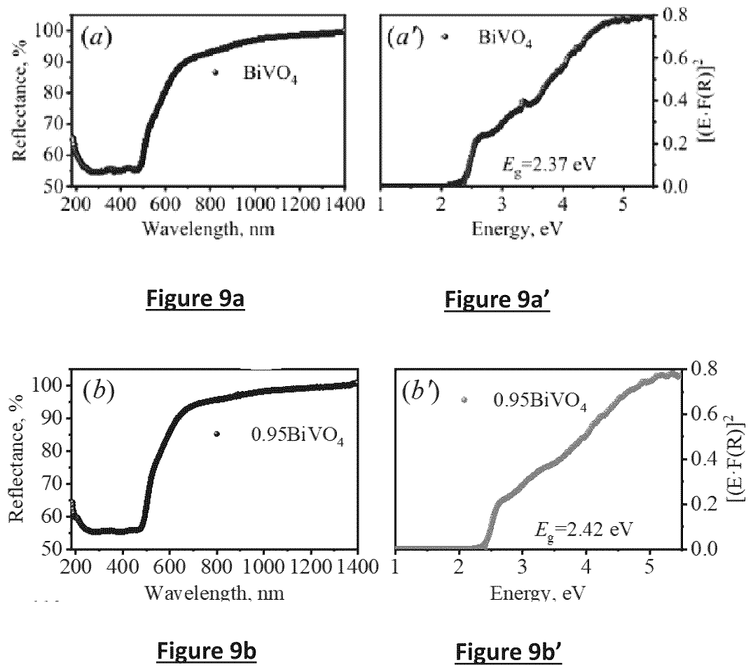

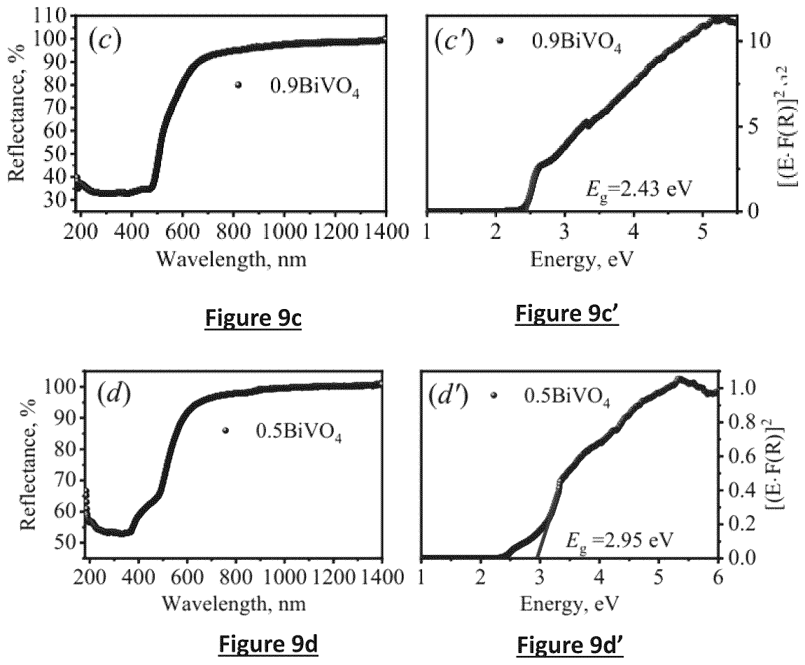

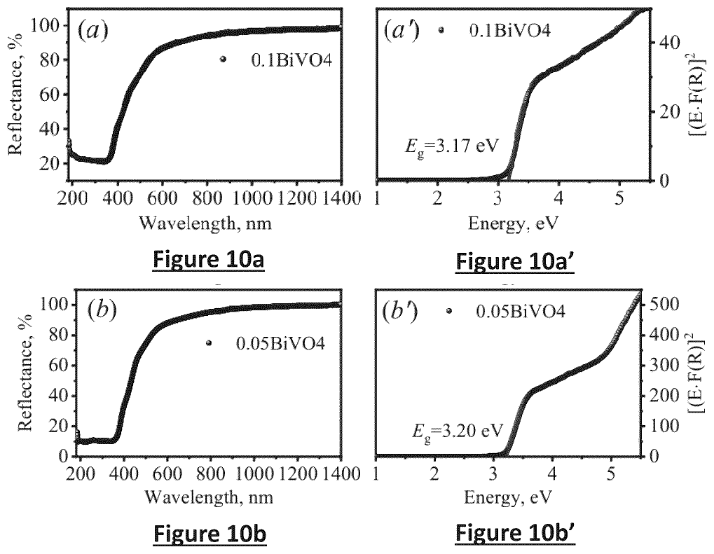

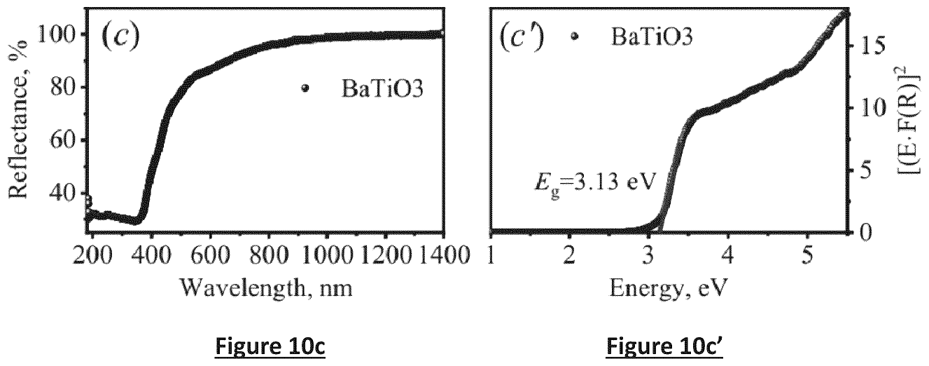

UV-Vis diffuse reflectance spectroscopy (DRS) analysis shown in FIG. 9 and FIG. 10 demonstrating the redshift in absorption edge and bandgap narrowing from pure BaTiO₃ to pure BiVO₄.

FIG. 9 (a-d) illustrates UV-Vis Diffuse Reflectance Spectroscopy (DRS) Analysis of (1−x)BiVO₄-xBaTiO₃ composites. FIG. 9(a) illustrates UV-Vis DRS spectrum of BiVO₄ with absorption edge near 520 nm. FIG. 9(a′) illustrates Optical bandgap of BiVO₄ determined as 2.37 eV. FIG. 9(b) illustrates UV-Vis DRS spectrum of 0.95BiVO₄ composite with absorption edge near 512 nm. FIG. 9(b′) illustrates Optical bandgap of 0.95BiVO₄ composite determined as 2.42 eV. FIG. 9(c) illustrates UV-Vis DRS spectrum of 0.9BiVO₄ composite with absorption edge near 510 nm. FIG. 9(c′) illustrates Optical bandgap of 0.9BiVO₄ composite determined as 2.43 eV. FIG. 9(d) illustrates UV-Vis DRS spectrum of 0.5BiVO₄ composite with absorption edge near 420 nm. FIG. 9(d′) illustrates Optical bandgap of 0.5BiVO₄ composite determined as 2.95 eV.

FIG. 10 (a-d) illustrates UV-Vis Diffuse Reflectance Spectroscopy (DRS) Analysis of (1−x)BiVO₄-xBaTiO₃ composites. FIG. 10(a) illustrates UV-Vis DRS spectrum of 0.1BiVO₄ composite with absorption edge near 390 nm. FIG. 10(a′) illustrates Optical bandgap of 0.1BiVO₄ composite determined as 3.17 eV. FIG. 10(b) illustrates UV-Vis DRS spectrum of 0.05BiVO₄ composite with absorption edge near 388 nm. FIG. 10(b′) illustrates Optical bandgap of 0.05BiVO₄ composite determined as 3.20 eV. FIG. 10(c) illustrates UV-Vis DRS spectrum of BaTiO₃ with absorption edge near 396 nm. FIG. 10(c′) illustrates Optical bandgap of BaTiO₃ determined as 3.13 eV.

FIG. 9 (a-d) and FIG. 10 (a-d) shows UV-Vis spectroscopy is a crucial tool for analysing the optical properties and bandgap variations in the (1−x)BaTiO₃+x BiVO₄ system. The provided spectra help us understand how the incorporation of BiVO₄ into the BaTiO₃ matrix influences light absorption and electronic structure. In the pure BaTiO₃ sample (x=0), the absorption edge appears in the ultraviolet (UV) region (˜380 nm), which is typical for BaTiO₃due to its wide bandgap (˜3.2 eV). This wide bandgap makes BaTiO₃ suitable for applications in dielectric materials but limits its photocatalytic activity in the visible region. The sharp absorption onset indicates a highly crystalline nature with minimal defects or impurity states affecting the electronic transitions.

As BiVO₄ content increases (x=0.05, 0.1), a significant redshift in the absorption edge is observed, indicating a reduction in the bandgap. The incorporation of BiVO₄ introduces localized states within the band structure, allowing enhanced absorption in the visible region. At x=0.5, the absorption profile reflects a mixed-phase system, where both BaTiO₃ and BiVO₄ contribute to the optical transitions. The presence of BiVO₄, which has a lower bandgap (˜2.4 eV), extends the absorption further into the visible spectrum (˜500 nm), improving the material's potential for visible-light-driven applications.

For higher BiVO₄ concentrations (x=0.9 and 1), the spectra show a dominant absorption in the visible range (˜500 nm and beyond), confirming the strong influence of BiVO₄. The calculated bandgap values, estimated using Tauc's plot method (αhv=A(hv−Eg)nαhv=A(hv−Eg)n), confirm a gradual transition from 3.2 eV (pure BaTiO₃) to ˜2.4 eV (pure BiVO₄). This significant reduction in the bandgap suggests that increasing BiVO₄ content enhances visible-light absorption, making the material suitable for applications in photocatalysis and optoelectronic devices.

The UV-Vis analysis demonstrates a systematic tunability of optical properties in the (1−x) BaTiO₃+x BiVO₄ system. The progressive redshift in absorption and bandgap narrowing highlight the synergistic effects of BaTiO₃ and BiVO₄. While BaTiO₃ maintains structural stability and dielectric properties, BiVO₄ enhances visible-light absorption and photocatalytic potential. The ability to tailor optical characteristics by adjusting x makes this system highly versatile for energy conversion, optoelectronics, and solar-driven applications.

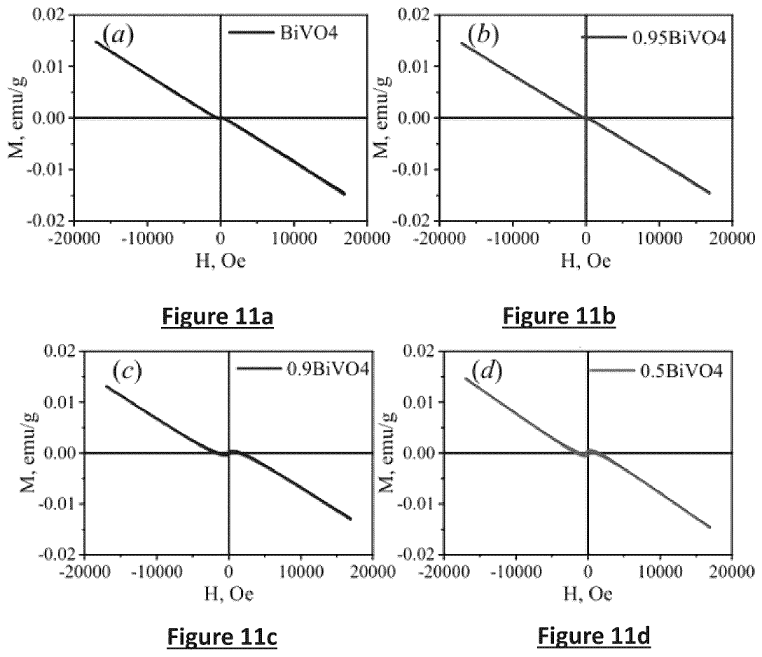

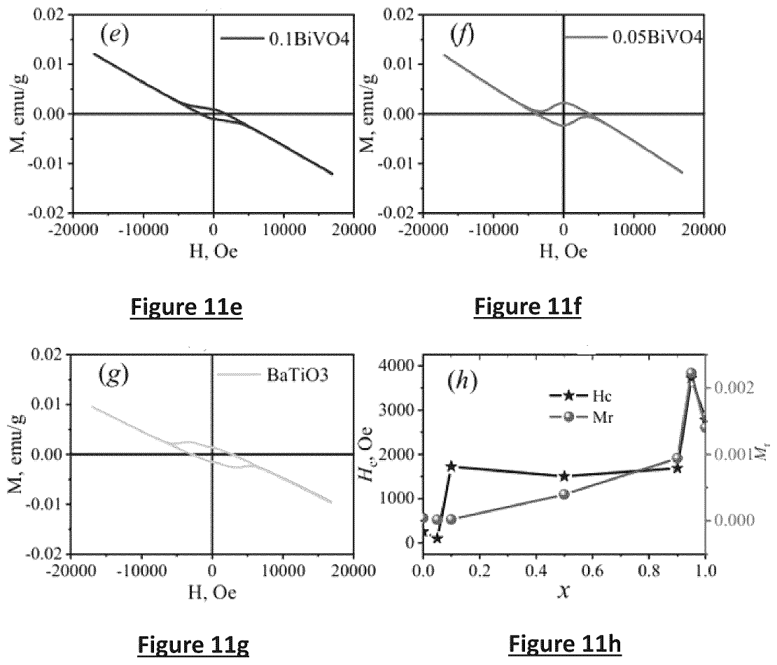

FIG. 11(a-h) illustrates Magnetic hysteresis loops (a-g) and concentration dependence of H_{c}, Mᵣ (h) of (1−x)BiVO₄-xBaTiO₃ composites. Magnetization (M-H) hysteresis loops and compositional dependence of coercivity (Hc) and remanence (Mr), showing the transition from diamagnetic to weak ferromagnetic behavior. FIG. 11(a) illustrates Magnetic hysteresis loop of BiVO₄ measured at room temperature. FIG. 11(b) illustrates Magnetic hysteresis loop of 0.95BiVO₄ composite. FIG. 11(c) illustrates Magnetic hysteresis loop of 0.9BiVO₄ composite. FIG. 11(d) illustrates Magnetic hysteresis loop of 0.5BiVO₄ composite. FIG. 11 (e) illustrates Magnetic hysteresis loop of 0.1BiVO₄ composite. FIG. 11(f) illustrates Magnetic hysteresis loop of 0.05BiVO₄ composite. FIG. 11(g) illustrates Magnetic hysteresis loop of BaTiO₃. FIG. 11(h) illustrates Variation of coercivity (Hc) and remanent magnetization (Mr) as a function of BiVO₄ concentration in (1−x)BiVO₄+xBaTiO₃ composites.

FIG. 11 (a-h) shows Magnetization versus applied field (M-H) hysteresis loops provide insights into the magnetic behavior and phase transitions of the (1−x) BaTiO₃+x BiVO₄ composite system. BaTiO₃ is typically a non-magnetic dielectric material, while BiVO₄ exhibits paramagnetic behavior due to unpaired electrons in vanadium (V⁵⁺) ions. The progressive introduction of BiVO₄ into BaTiO₃ influences the magnetic properties, leading to variations in paramagnetism, diamagnetism, and weak ferromagnetism across different compositions.

For x=0 (pure BaTiO₃), the M-H loop is almost linear, indicating diamagnetic behavior typical of BaTiO₃. There is negligible coercivity and remanence, confirming the absence of intrinsic magnetism. As BiVO₄ is introduced (x=0.05, 0.1), the loop begins to show a slight non-linearity, suggesting the emergence of weak paramagnetic contributions due to the presence of V⁵⁺ ions. The minor increase in magnetization could be attributed to defect statesor oxygen vacancies, which can induce localized magnetic moments in the lattice.

At x=0.5, the M-H loop exhibits enhanced paramagnetic behavior, with a more pronounced curvature. This suggests a synergistic interaction between BaTiO₃ and BiVO₄, where the increase in vanadium content enhances the overall magnetic response. The slight increase in remanent magnetization (MrMr) and coercivity (HcHc) indicates the presence of localized magnetic interactions, possibly due to oxygen vacancies or structural distortions at the interface of BaTiO₃ and BiVO₄ phases.

For higher BiVO₄ content (x=0.9, 1), the magnetization increases further, with the M-H loop resembling a weak ferromagnetic response. The presence of a small hysteresis loop and a nonzero remanent magnetization suggests the dominance of BiVO₄'s paramagnetic nature, along with possible induced weak ferromagnetism due to structural distortions and defect-induced spin interactions. The trend in MrMr values, as shown in the inset graph, confirms an increasing trend in magnetization with increasing x, reaching a maximum around x=0.9. This suggests that BiVO₄ incorporation significantly modifies the magnetic behavior, introducing paramagnetism and weak ferromagnetic interactions.

FIG. 12 (a-c) illustrates First-order reversal curve (FORC)-type diagrams for (1−x)BiVO₄-xBaTiO₃ composites. First-order reversal curve (FORC) diagrams for the composite series depicting magnetic interaction field distributions and coercivity evolution with varying compositions. FIG. 12(a) illustrates FORC curve of 0.1BiVO₄ composite. FIG. 12(a′) illustrates FORC distribution contour map of 0.1BiVO₄ composite. FIG. 12(b) illustrates FORC curve of 0.05BiVO₄ composite. FIG. 12(b′) illustrates FORC distribution contour map of 0.05BiVO₄ composite. FIG. 12(c) illustrates FORC curve of BaTiO₃. FIG. 12(c′) illustrates FORC distribution contour map of BaTiO₃.

FIG. 12 (a-c) shows First-Order Reversal Curve (FORC) analysis is an advanced technique used to investigate the magnetic interactions, coercivity distribution, and phase transitions in magnetic materials. The provided FORC diagrams offer insights into the evolution of the magnetic response of (1−x) BaTiO₃+x BiVO₄ as BiVO₄ content increases. Since BaTiO₃ is inherently non-magnetic, its FORC distribution at x=0 is featureless, representing a purely diamagnetic response with negligible coercivity. The lack of strong interaction fields confirms that BaTiO₃ does not exhibit intrinsic magnetism, which aligns with its well-known dielectric nature.

As BiVO₄ is gradually incorporated (x=0.05 and 0.1), weak magnetic interactions begin to emerge. The FORC distributions show broad, low-intensity features, indicating the presence of localized paramagnetic contributions. This magnetic response can be attributed to oxygen vacancies and lattice distortions, which introduce unpaired electrons in V⁵⁺ ions. The FORC curves begin to exhibit slight curvature, suggesting that some degree of magnetic interactions is forming within the system. The presence of BiVO₄ creates localized regions of increased magnetization, leading to a more complex and evolving magnetic landscape.

At x=0.5, the FORC diagram presents a broadened coercivity range and increased interaction fields, indicating a stronger paramagnetic response. The more pronounced FORC features suggest that defect-driven magnetism and interfacial magnetic coupling between BaTiO₃ and BiVO₄ play a significant role in modifying the system's behavior. This marks a transition from a weakly magnetic to a more interacting system, where the combination of structural distortions, defects, and vanadium-related interactions contribute to an enhanced magnetic response. This intermediate composition demonstrates a mixed-phase regime where both BaTiO₃ and BiVO₄ influence the overall magnetic properties.

For higher BiVO₄ concentrations (x=0.9 and 1), the FORC distributions become more intense, with well-defined peaks and broadened coercivity fields. The presence of higher coercivity values and strong interaction fields confirms that BiVO₄ is the dominant magnetic contributor in the system. The increase in weak ferromagnetic interactions suggests that oxygen vacancies, structural distortions, and vanadium-based magnetism play a crucial role in modifying the material's behavior. The progressive transformation in the FORC diagrams confirms a gradual shift from a non-magnetic to a weakly ferromagnetic system, highlighting the tunability of magnetic properties in (1−x) BaTiO₃+x BiVO₄ composites.

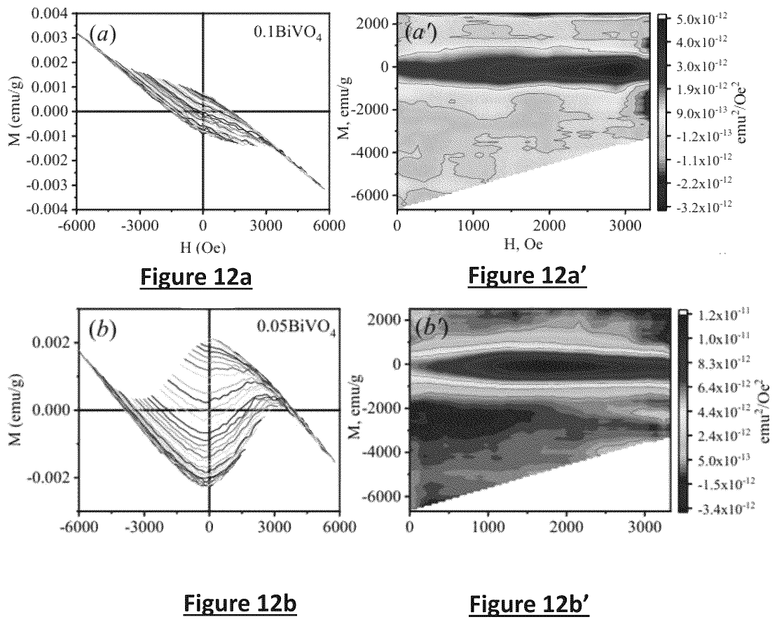

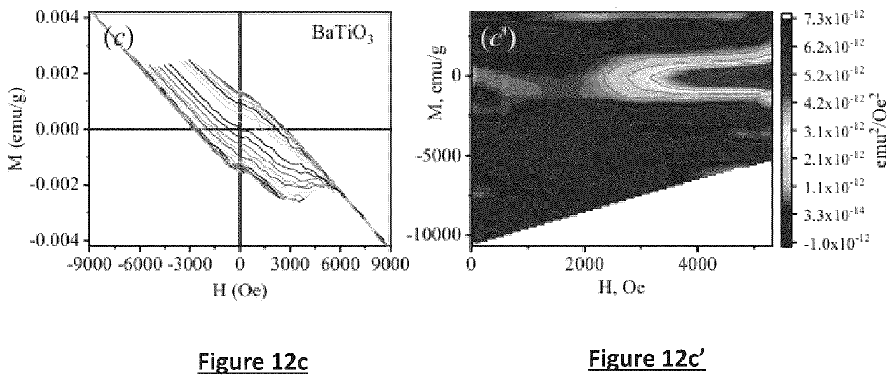

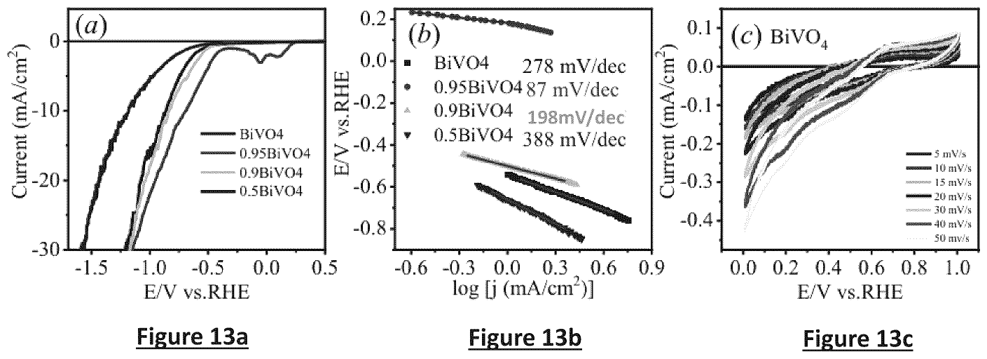

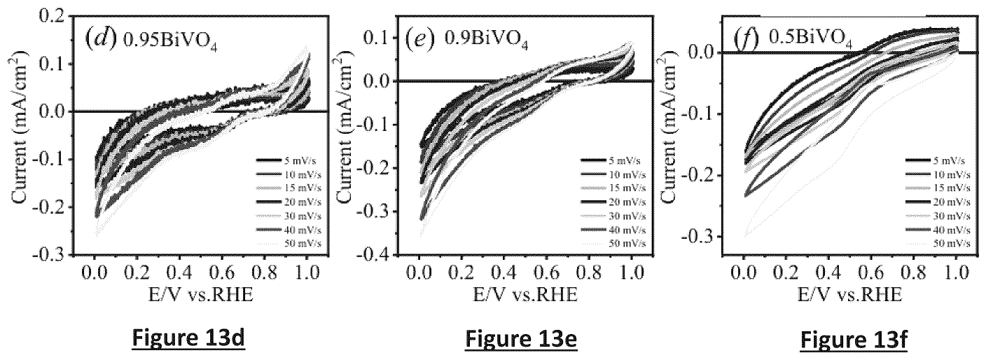

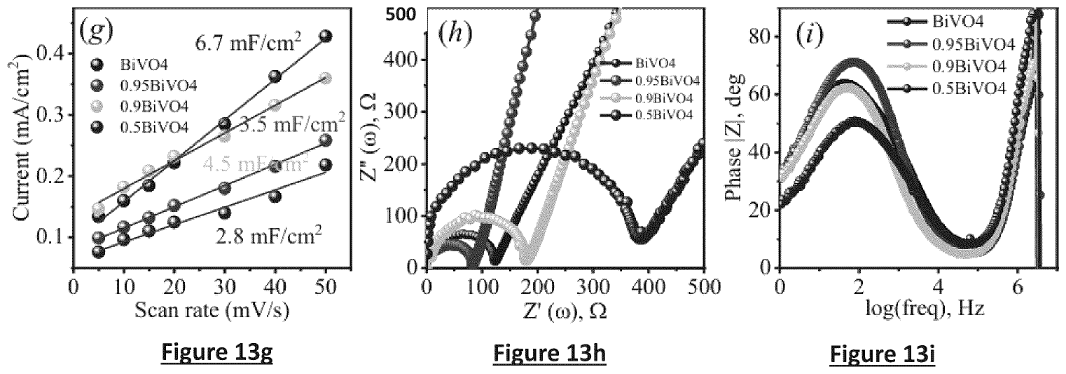

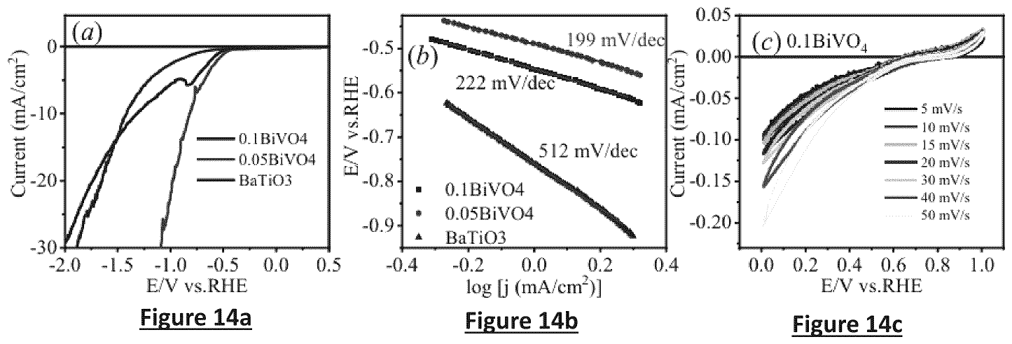

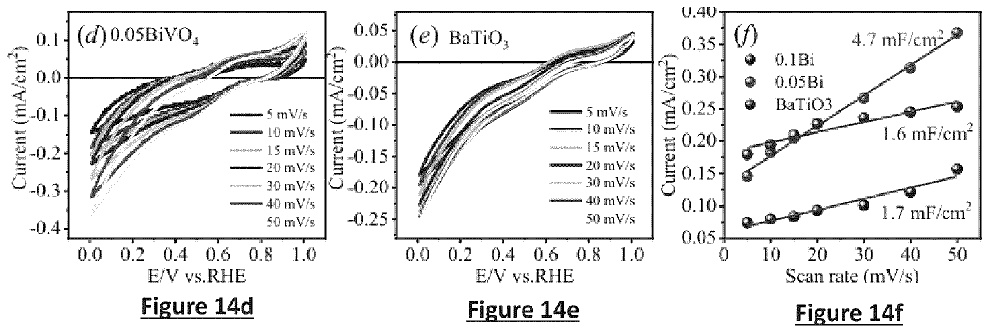

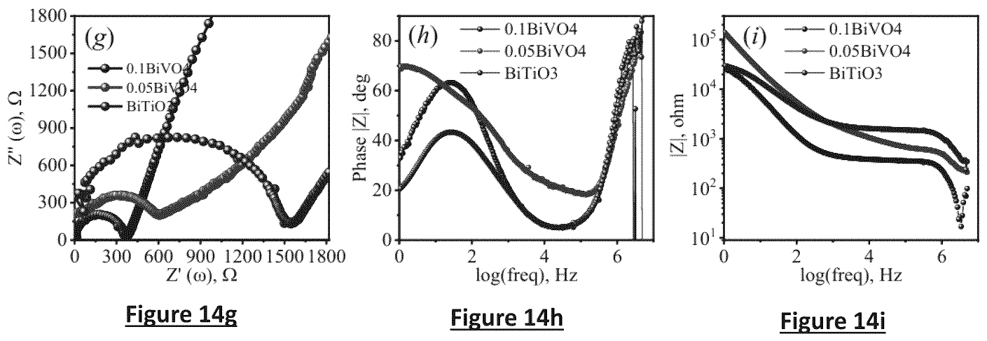

Electrochemical performance of the composites shown in FIG. 13 and FIG. 14 is evaluated through:
(a) Linear sweep voltammetry (LSV),
(b) Tafel slopes,
(c-e) Cyclic voltammetry (CV) curves,
(f) Capacitance vs scan rate plots,
(g) Nyquist (EIS) plots,
(h) Bode phase angle plots,
(i) Bode impedance curves—demonstrating enhanced HER activity and charge transport.

FIG. 13 (a-i) illustrate electrocatalytic HER performance of (1−x)BiVO₄-xBaTiO₃ composites. FIG. 13 (a) illustrates Linear sweep voltammetry curves of BiVO₄, 0.95BiVO₄, 0.9BiVO₄, and 0.5BiVO₄ composites. FIG. 13(b) illustrates Tafel slope values extracted for BiVO₄ and BiVO₄—BaTiO₃ composites. FIG. 13(c) illustrates Cyclic voltammetry response of BiVO₄ at varying scan rates. FIG. 13(d) illustrates Cyclic voltammetry response of 0.95BiVO₄ composite at varying scan rates. FIG. 13(e) illustrates Cyclic voltammetry response of 0.9BiVO₄ composite at varying scan rates. FIG. 13(f) illustrates Cyclic voltammetry response of 0.5BiVO₄ composite at varying scan rates. FIG. 13(g) illustrates Double-layer capacitance (Cdl) estimation from CV curves of BiVO₄ and composites. FIG. 13(h) illustrates Electrochemical impedance spectroscopy (Nyquist plot) of BiVO₄ and composites. FIG. 13(i) illustrates Bode phase angle plots of BiVO₄ and composites.

FIG. 13 (a-i) show electrocatalytic hydrogen evolution reaction (HER) performance of (1−x)BiVO₄-xBaTiO₃ composites is investigated through linear sweep voltammetry (LSV), Tafel slope analysis, cyclic voltammetry (CV), electrochemical impedance spectroscopy (EIS), and Bode phase angle measurements. These electrochemical techniques are crucial in understanding the catalytic efficiency, charge transfer behavior, and surface activity of the composite materials. The LSV curves illustrate how the incorporation of BaTiO₃ significantly influences HER activity. As the BaTiO₃ content increases, the onset potential for hydrogen evolution shifts toward more negative values, indicating a lower energy requirement for HER initiation. The increase in cathodic current density with decreasing overpotential suggests that BaTiO₃ enhances the electronic conductivity and active site density of the composite. This improvement can be attributed to BaTiO₃'s ability to facilitate electron transport and improve the catalytic interface, making the reaction more energetically favorable. Among the various compositions tested, the composite with the highest BaTiO₃ content exhibits the lowest overpotential, indicating superior HER performance.

To further examine the kinetic mechanisms governing the HER process, Tafel slope analysis is conducted. The Tafel slope values provide insights into the electron transfer rate and reaction pathways. A smaller Tafel slope signifies faster reaction kinetics, implying that the catalyst facilitates the hydrogen adsorption and desorption steps more efficiently. The HER process typically follows three mechanisms: the Volmer step (initial proton adsorption), the Heyrovsky step (proton-electron combination), or the Tafel step (hydrogen recombination). The Tafel slopes obtained for different compositions indicate a transition between Volmer-Heyrovsky and Volmer-Tafel mechanisms, depending on the BaTiO₃ concentration. The lower Tafel slope observed for BaTiO₃-rich compositions suggests that the catalyst supports rapid electron transport and proton reduction, making it more effective for hydrogen production. The presence of BaTiO₃ may introduce interfacial electric fields and surface polarization effects, which further enhance charge separation and reduce recombination losses, ultimately accelerating the HER kinetics.

The cyclic voltammetry (CV) analysis further supports the enhanced HER activity by evaluating the electrochemically active surface area (ECSA). The CV curves show that the double-layer capacitance increases with the incorporation of BaTiO₃, suggesting an increase in the density of catalytically active sites. The greater capacitance implies that BaTiO₃ enhances the electrode-electrolyte interface, allowing for more efficient proton adsorption and charge accumulation. The ability of BaTiO₃ to act as a dielectric material with high permittivity may also contribute to better charge redistribution and interfacial charge transfer, further improving HER activity. The correlation between double-layer capacitance and HER efficiency confirms that the BaTiO₃—BiVO₄ composite optimally balances electronic conductivity and catalytic site accessibility, leading to a highly efficient HER electrocatalyst.

To investigate the charge transport characteristics and interfacial resistance, electrochemical impedance spectroscopy (EIS) is performed. The Nyquist plots reveal a significant decrease in the charge transfer resistance (R_ct) with increasing BaTiO₃ content. A lower R_ct means that electrons can move more freely within the catalyst structure, reducing energy barriers and facilitating faster HER reactions. This behavior indicates that BaTiO₃ enhances the conductivity of BiVO₄, likely by reducing recombination effects and improving carrier mobility. The Bode phase angle analysis provides additional confirmation of improved charge storage properties, with the optimized composite showing a higher phase angle at lower frequencies, characteristic of better capacitive behavior. This suggests that the composite exhibits efficient charge retention and rapid charge-discharge cycles, which are critical for maintaining stable HER performance over extended periods.

The electrocatalytic HER analysis of (1−x)BiVO₄-xBaTiO₃ composites reveals a progressive enhancement in catalytic activity with increasing BaTiO₃ content. The incorporation of BaTiO₃ leads to reduced overpotentials, lower Tafel slopes, higher electrochemically active surface areas, and improved charge transfer kinetics, all of which contribute to superior HER efficiency. The synergy between BiVO₄'s catalytic activity and BaTiO₃'s dielectric properties creates a highly effective composite for hydrogen production. The optimized BaTiO₃—BiVO₄ catalyst not only exhibits excellent HER activity but also demonstrates improved charge transport, reduced recombination losses, and better catalytic stability, making it a promising material for renewable energy and green hydrogen applications. The study highlights how the strategic integration of ferroelectric materials like BaTiO₃ into semiconductor-based catalysts can significantly enhance electrocatalytic performance, paving the way for future advancements in hydrogen generation and sustainable energy conversion technologies.

The electrocatalytic HER performance of (1−x)BiVO₄-xBaTiO₃ composites is analyzed through a series of electrochemical techniques, including linear sweep voltammetry (LSV), Tafel slope analysis, cyclic voltammetry (CV), electrochemical impedance spectroscopy (EIS), and Bode phase analysis. These measurements provide crucial insights into the catalytic efficiency, charge transfer kinetics, and interfacial electrochemical behaviour of the composites. The incorporation of BaTiO₃ into BiVO₄ significantly impacts the HER activity by modifying charge transport properties and altering the density of active sites.

The LSV curves (Figure a) reveal a systematic decrease in overpotential with increasing BaTiO₃ content, indicating an improvement in HER catalytic efficiency. A lower onset potential and a higher cathodic current density signify an enhanced ability to drive hydrogen evolution at lower energy input. Among the tested compositions, the BaTiO₃-rich samples exhibit the lowest overpotential, suggesting that BaTiO₃ acts as an effective charge transport mediator, reducing recombination losses and improving catalytic activity. The Tafel slope analysis (Figure b) further confirms this trend, where a lower Tafel slope corresponds to faster reaction kinetics. The composite with a Tafel slope of 199 mV/dec shows a significant improvement over the one with 512 mV/dec, indicating a transition towards a more efficient HER mechanism. The observed values suggest that hydrogen evolution follows a Volmer-Heyrovsky pathway, where BaTiO₃ enhances electron transfer and reduces kinetic barriers.

The cyclic voltammetry (CV) curves (Figures c-e) provide insights into the electrochemically active surface area (ECSA) of the composites. The increased double-layer capacitance with higher BaTiO₃ content confirms the presence of more electrochemical active sites, allowing better proton adsorption and faster charge transfer. The capacitance values extracted from the linear fit of capacitive current versus scan rates (Figure f) further validate this behavior. The capacitance increase from 1.6 mF/cm² to 4.7 mF/cm² demonstrates the synergistic effect of BaTiO₃ in enhancing surface activity, making the composite more efficient for HER. The presence of high permittivity BaTiO₃ likely contributes to a strong local electric field, facilitating charge redistribution and improving electrocatalyst efficiency.

To further understand charge transport and interfacial behavior, electrochemical impedance spectroscopy (EIS) (Figure g) is used to evaluate charge transfer resistance (R_ct). A smaller Nyquist semicircle corresponds to lower resistance, indicating improved electron mobility and charge exchange between the electrode and electrolyte. The optimized composite exhibits the smallest R_ct, confirming that BaTiO₃ reduces interfacial resistance and enhances carrier transport. The Bode phase angle plot (Figure h) further highlights the impact of BaTiO₃ on charge storage and relaxation, where a higher phase angle at lower frequencies suggests improved capacitive charge retention. Finally, the Bode impedance curves (Figure i) provide insights into the electrochemical stability and overall impedance behavior, further confirming that BaTiO₃ enhances HER performance by improving charge transport dynamics and active site availability.

FIG. 14 illustrates Electrocatalytic HER for (1−x)BiVO₄-xBaTiO₃ composites (a) linear sweep voltammetry curves (b) Tafel plots derived from the corresponding polarization curves, (c-e) cyclic voltammetric curves, (f) Linear fit of the capacitive current versus scan rates, (g) EIS curve, (h) Bode phase angle and (i) Bode impedance curves. FIG. 14(a) illustrates Linear sweep voltammetry curves of 0.1BiVO₄, 0.05BiVO₄, and BaTiO₃ composites. FIG. 14(b) illustrates Tafel slope plots derived from polarization data of 0.1BiVO₄, 0.05BiVO₄, and BaTiO₃. FIG. 14(c) illustrates Cyclic voltammetry curves of 0.1BiVO₄ at varying scan rates. FIG. 14(d) illustrates Cyclic voltammetry curves of 0.05BiVO₄ at varying scan rates. FIG. 14(e) illustrates Cyclic voltammetry curves of BaTiO₃ at varying scan rates. FIG. 14(f) illustrates Linear fit of capacitive current versus scan rate for double-layer capacitance evaluation. FIG. 14(g) illustrates Nyquist impedance plot from EIS measurements of 0.1BiVO₄, 0.05BiVO₄, and BaTiO₃ composites. FIG. 14(h) illustrates Bode phase angle response of 0.1BiVO₄, 0.05BiVO₄, and BaTiO₃ composites. FIG. 14(i) illustrates Bode impedance plots of 0.1BiVO₄, 0.05BiVO₄, and BaTiO₃ composites.

The present invention relates to a composite material comprising (1−x)BaTiO₃+xBiVO₄, where 0≤x≤1, uniquely characterized by a heterostructured interface that enhances interfacial charge separation and significantly improves hydrogen evolution reaction (HER) performance. The composite material integrates the tetragonal phase of BaTiO₃ with the monoclinic phase of BiVO₄, creating a structurally and functionally optimized system. A notable feature of this composite is its tunable bandgap, which ranges from 3.2 eV (for pure BaTiO₃) to 2.4 eV (for pure BiVO₄), enabling efficient absorption in the visible-light spectrum, thereby improving photocatalytic efficiency. The material exhibits a type-II band alignment at the BaTiO₃—BiVO₄ interface, which facilitates directional electron transport while suppressing charge recombination, resulting in more effective catalytic action. Among the various compositions tested, the composite with x=0.9 demonstrates the lowest HER overpotential and the smallest Tafel slope, indicating optimal catalytic activity. Electrochemical analysis further reveals that the composite exhibits increased electrochemical double-layer capacitance and reduced charge transfer resistance, as verified by cyclic voltammetry and electrochemical impedance spectroscopy.

The method for synthesizing the composite includes calcining a mixture of BaCO₃ and TiO₂ at approximately 1300° C. to produce BaTiO₃, and a mixture of Bi₂O₃ and V₂O₅ at approximately 700° C. to produce BiVO₄. These synthesized powders are then physically mixed in (1−x):x molar ratios, pressed into pellets, and calcined at 700° C. to achieve a homogenous composite structure. The catalytic performance of the composite is further enhanced by interfacial polarization generated by BaTiO₃, which induces a spontaneous internal electric field that boosts charge mobility and reaction kinetics.

Additionally, the material exhibits weak ferromagnetic behavior at higher BiVO₄ concentrations, attributed to oxygen vacancies and lattice distortions, adding to its multifunctional character. The composite is particularly suited for application in electrochemical electrodes, where it can be configured for hydrogen generation, use in supercapacitors, and broader energy storage systems. This invention thus offers a scalable, cost-effective, and high-performance material platform for clean energy technologies. The invention details a synthesis process where barium titanate (BaTiO₃) and bismuth vanadate (BiVO₄) are first independently prepared using solid-state reactions. Following their individual synthesis, these materials are then composited together in varying molar ratios, specifically from x=0 to x=1. The resulting heterostructures undergo thorough characterization using a range of analytical techniques, including X-ray Diffraction (XRD), X-ray Fluorescence (XRF), Ultraviolet-Visible (UV-Vis) spectroscopy, Fourier-transform Infrared (FTIR) spectroscopy, Raman spectroscopy, Scanning Electron Microscopy (SEM), Vibrating Sample Magnetometry (VSM), and electrochemical analysis. Crucially, the interfacial coupling within these heterostructures generates internal electric fields that play a significant role in enhancing charge mobility and storage capacity within the composite material.

This inventive composite material offers several key advantages. It provides enhanced electrocatalytic activity, making it particularly suitable for applications such as green hydrogen production through water splitting. The material also exhibits tunable electronic and magnetic properties, which makes it highly adaptable for a wide array of multifunctional applications. Furthermore, the composite demonstrates improved charge transport and energy storage performance. A significant benefit is its scalable and reproducible synthesis method, which utilizes low-cost solid-state processing, making it practical for industrial implementation.

The applications for this invention are diverse and impactful. The composite material is well-suited for use as hydrogen evolution catalysts in water splitting processes, contributing to sustainable energy solutions. It can also function effectively as electrode materials for advanced supercapacitors and batteries, enhancing energy storage capabilities. Beyond energy applications, the material is also promising for various uses in optoelectronics, sensors, and photocatalytic reactors, showcasing its versatility and potential across multiple technological fields.

The present invention introduces a novel ferroelectric-semiconductor composite material composed of a (1−x)BaTiO₃+xBiVO₄ heterostructure, where the value of x ranges from 0 to 1. This advanced composite system is meticulously designed to address critical challenges in the domains of electrocatalytic hydrogen production and energy storage. By combining the high dielectric and ferroelectric characteristics of BaTiO₃ with the visible-light-responsive photocatalytic behavior of BiVO₄, the invention leverages the individual strengths of each component to create a synergistically enhanced material.

A significant feature of this composite is its tunable bandgap, which can be engineered from approximately 3.2 eV to 2.4 eV by adjusting the composition ratio. This tuning results in a progressive structural transformation from tetragonal perovskite BaTiO₃ to monoclinic BiVO₄. Furthermore, density functional theory (DFT) calculations confirm a type-II band alignment at the heterojunction interface, which plays a pivotal role in enabling efficient charge separation and facilitating directional electron transport across the junction—an essential factor for high-performance energy applications.

The composite demonstrates a marked enhancement in hydrogen evolution reaction (HER) performance, particularly at the optimized composition of x=0.9. Key improvements include reduced overpotential, a lower Tafel slope, and a larger electrochemical surface area. These enhancements are primarily attributed to interfacial ferroelectric polarization, which generates an internal electric field that boosts charge carrier mobility and significantly reduces recombination losses. In addition to superior electrochemical characteristics, the material exhibits tunable magnetic behavior, shifting from diamagnetic to weakly ferromagnetic properties, and improved optical absorption within the visible light spectrum. These features make the composite highly versatile and suitable for applications beyond energy storage, including photocatalysis and optoelectronics.

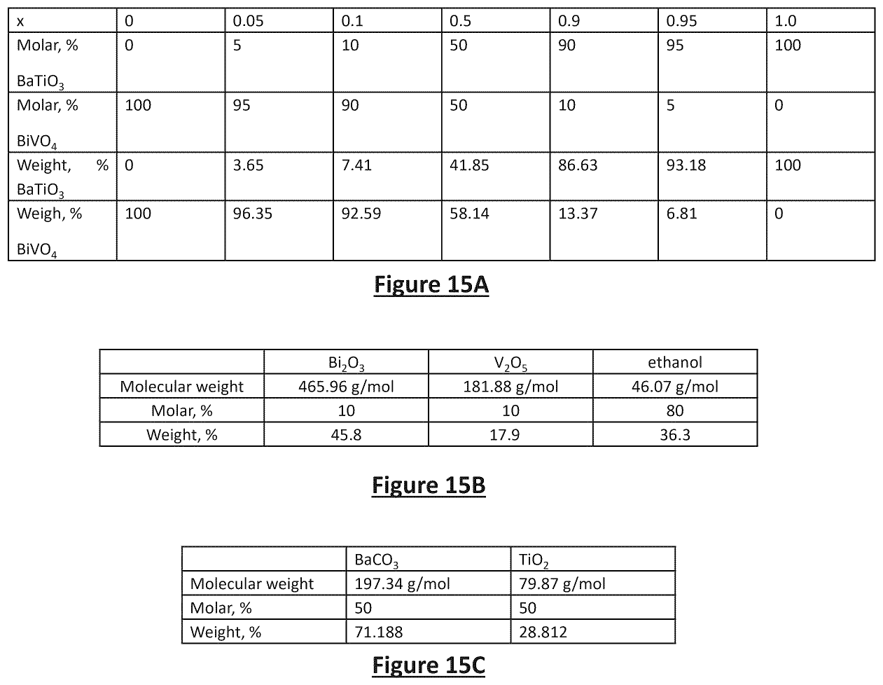

FIG. 15A, illustrates a Table depicting weight of BiVO₄, with BaTiO₃. FIG. 15B illustrates a Table depicting weight of Bi₂O₃, with V₂O₅. FIG. 15C illustrates a Table depicting weight of BaCO₃, with TiO₂.

The invention presents a scalable and cost-effective solution for multiple advanced technologies. It is particularly well-suited for use in water-splitting electrodes, hydrogen production systems, electrochemical supercapacitors and batteries, as well as photocatalytic and dielectric devices. By harnessing the synergistic interaction between ferroelectric and semiconductor materials, this multifunctional composite system paves the way for next-generation green energy conversion and storage solutions.

The composite at x=0.95 (i.e., 95 mol % BiVO₄) exhibits the lowest Tafel slope (87 mV/dec). and this concentration also has relatively higher capacitance value (3.5 mF/cm₂), calculated from CV.

Charge transfer resistance (EIS): Smallest (lowest Rct) for the x=0.95 (i.e., 95 mol % BiVO₄) composite.

### Preparation of Catalyst Suspension

Drop casting technique: The 10 mg of pre-synthesized BiVO₄—BaTiO₃ composite powder is first dispersed in 1 mL ethanol. One drop of binder Nafion (5 wt %, Alfa Aesar) were added to enhance adhesion of the catalyst to the substrate. The mixture is ultrasonicated for 20 minutes to ensure a homogeneous and stable suspension.

### Substrate Preparation

A glassy carbon (GC) electrode was cleaned by sequentially sonicating in ethanol, and then dried. This ensures good wetting and contact between the catalyst and the electrode.

### Drop Casting Procedure

A drop of the well-dispersed catalyst ink is pipetted onto the clean substrate's surface.

The drop is allowed to spread naturally or gently blown with air to ensure even coverage.

The substrate is then dried in a mild oven at 60° C. for 30-60 minutes, to evaporate the solvent and fix the composite layer.

### Electrode Assembly

The coated substrate serves as the working electrode in a standard three-electrode cell.

The electrode is immersed in 1 M NaOH electrolyte, which has a pH of 14. For a pH=14 solution, conversion from Ag/AgCl to RHE is straightforward using:

$${E}_{RHE} = {E}_{Ag / AgCl} + 0.059 \times pH + {E}_{Ag / AgCl}^{0}$$

Here, 0.197 V is the standard potential of the Ag/AgCl

$${E}_{RHE} = {E}_{Ag / AgCl} + 0.059 \times 14 + 0.197 = {E}_{Ag / AgCl} + 1.0 \; 23 V$$

This direct conversion simplifies data reporting for hydrogen evolution reaction (HER) measurements under alkaline conditions.

To avoid the possible influence of platinum dissolution or migration during electrochemical measurements, graphene was used as the counter electrode instead of conventional Pt wire or Pt plate. It is well-known that under HER conditions, Pt can undergo dissolution and redeposition onto the working electrode surface, which can artificially enhance the observed electrocatalytic activity. Using a graphene counter electrode eliminates this risk and ensures that the measured hydrogen evolution activity originates solely from the BiVO₄—BaTiO₃ composite catalyst. The reference electrode was Ag/AgCl, and all potentials were initially measured against this reference. For comparison and clarity, the potentials were subsequently converted to the reversible hydrogen electrode (RHE) scale.

1. A method for synthesizing a ferroelectric-semiconductor composite material for enhanced electrocatalytic and energy storage applications, comprises:
synthesizing BiVO₄ powder upon treating 45.8 wt. % of Bi₂O₃ and 17.9 wt. % of 36.3V₂O₅;
synthesizing BaTiO₃ powder upon treating 71.188 wt. % of BaCO₃ with 28.812 wt. % of TiO₂;
mixing the synthesized 100-0 wt. % of BiVO₄ powder and 0-100 wt. % of BaTiO₃ powder in molar ratios of (1−x):x for approximately 1 hour to form a mixture;
pressing the mixture into a first pellet; and
calcining the first pellet at approximately 700° C. for approximately 4 hours thereby cooling the pellet to room temperature to form a (1−x)BaTiO₃+xBiVO₄ composite, wherein the pressing of the mixture into the first pellet is carried out under a uniaxial pressure of 250 MPa while simultaneously applying an external alternating electric field of 0.5-1.0 kV/cm across the die assembly, such that partial alignment of BaTiO₃ ferroelectric dipoles is induced prior to calcination, wherein said pre-polarization state is retained during subsequent sintering and results in enhanced internal electric fields within the composite; and wherein the calcining at 700° C. is performed under a dynamic atmosphere comprising alternating 15-minute cycles of oxygen-rich gas comprising 90% O₂ and 10% N₂ at a flow rate of approximately 100 sccm, and mildly reducing gas comprising 95% N₂ and 5% H₂ at a flow rate of approximately 100 sccm, thereby forming a heterointerface comprising oxygen-rich BiVO₄ domains and defect-stabilized BaTiO₃ domains; and
wherein the mixture of BiVO₄ and BaTiO₃ powders is pre-milled in a staged sequence comprising (a) coarse planetary milling at 300 rpm for 2 hours with 10 mm zirconia balls, followed by (b) fine attrition milling at 800 rpm for 1 hour with 2 mm zirconia beads in isopropanol medium, and wherein this staged milling produces a bimodal particle size distribution with dso between 80-120 nm for BiVO₄ and dso between 200-300 nm for BaTiO₃, such distribution enhancing space-charge layer formation at phase boundaries and yielding an increase in double-layer capacitance by at least 20% relative to unimodal powders.

2. The method of claim 1, wherein the synthesizing BiVO₄ powder comprising:
mixing and grinding 45.8 wt. % of Bi₂O₃ and 17.9 wt. % of 36.3V₂O₅ with wt. % of ethanol for approximately 3 hours to form a mixture;
pressing the mixture into a second pellet;
calcining the second pellet at approximately 500-1000° C. for approximately 2-6 hours;
allowing the second pellet to cool naturally to room temperature;
grinding the cooled second pellet into a BiVO₄ powder; and
re-calcining the BiVO₄ powder at approximately 700° C. for approximately 2 hours; wherein the second pellet is calcinated in a muffle furnace at approximately 700° C. for approximately 4 hours.

3. The method of claim 2, wherein the synthesizing BaTiO₃ powder comprising:
mixing and grinding 71.188 wt. % of BaCO₃ with 28.812 wt. % of TiO₂ for approximately 4 hours to form a mixture;
pressing the mixture into a third pellet;
calcining the third pellet at approximately 1000-1500° C. for approximately 2-6 hours, wherein the third pellet is calcinated at approximately 1300° C. for approximately 4 hours; and
allowing the third pellet to cool naturally to room temperature; wherein the grinding is performed in an agate mortar.

4. The method of claim 1, wherein the molar ratio x for the composite material is selected from the group consisting of 0,0.05,0.1,0.5,0.9, and 0.95, wherein the composite material comprises 95 mol % BiVO₄ and 5 mol % BaTiO₃; and wherein the bandgap of the composite is tunable between 3.2 eV for BaTiO₃ and 2.4 eV for BiVO₄, enabling absorption in the visible-light spectrum.

5. The method of claim 4, wherein the composite material comprising 95 mol % BiVO₄ and 5 mol % BaTiO₃ is subjected to a secondary annealing step under rapid thermal processing (RTP) at 800-850° C. with a ramp rate of 50° C./s and a dwell time of 120 seconds, wherein said transient annealing induces localized lattice distortion and partial Ti⁴⁺-V⁵⁺ substitution at interfacial regions, thereby narrowing the composite bandgap to between 2.3-2.5 eV while simultaneously preserving BaTiO₃ ferroelectric ordering, and wherein such structural modification yields a photocurrent density exceeding 12 mA/cm² at 1.23 V versus RHE.

6. The method of claim 1, wherein the cooling of the calcined pellet is carried out in a two-stage gradient atmosphere, comprising a first stage slow cooling at 2° C./min down to 500° C. in flowing oxygen at 150 sccm, followed by a second stage quenching at 10° C./min to room temperature in argon, wherein this dual cooling regime suppresses formation of microcracks while simultaneously stabilizing polar nanoregions in BaTiO₃; and wherein the mixture ratio (1−x):x is configured such that a percolation threshold is achieved at x=0.05-0.1, thereby creating a continuous BiVO₄ conduction pathway embedded within a ferroelectric BaTiO₃ matrix.

7. The method of claim 1, wherein during calcination the furnace chamber is doped with a volatile ammonium vanadate precursor vapor at a concentration of 10-30 ppm, wherein said vapor promotes partial substitution of V⁵⁺ into the BaTiO₃ lattice near the interfacial regions, thereby generating localized donor states within the band structure, wherein the pellet is subjected to spark plasma sintering (SPS) at a pressure of 40-60 MPa, pulsed DC current of 200-300 A, and a temperature ramp rate of 100° C./min up to 750-800° C. with a dwell time of 10 minutes, wherein said rapid field-assisted sintering inhibits exaggerated grain growth, maintains nanostructured interfaces with grain size below 150 nm, and enhances interfacial polarization coupling, thereby increasing oxygen evolution reaction (OER) turnover frequency by at least 25% compared to conventionally sintered pellets; and
wherein SPS sintering is followed by annealing in a humidified oxygen atmosphere at 600° C. for 1 hour with relative humidity maintained at 5-10%, wherein said humid annealing generates surface hydroxyl functional groups on BiVO₄ domains, thereby improving surface wettability and enhancing electrode-electrolyte interaction during electrocatalysis, resulting in improved catalytic stability over 10,000 chronoamperometric cycles.

8. The method of claim 1, wherein the composite powder obtained after calcination is incorporated into an electrode slurry comprising 80-85 wt. % composite material, 10-15 wt. % conductive carbon black, and 5 wt. % polyvinylidene fluoride (PVDF) binder dissolved in N-methyl-2-pyrrolidone (NMP), wherein the slurry is ultrasonicated for 1 hour to ensure homogeneous dispersion and subsequently cast onto a nickel foam current collector with areal loading of 2-3 mg/cm², followed by vacuum drying at 120° C. for 12 hours.

9. The method of claim 1, wherein the BiVO₄—BaTiO₃ composite is processed by sequential powder layering during pellet pressing, such that the pellet comprises an inner BaTiO₃-rich core (x<0.2) and an outer BiVO₄-rich shell (x>0.8), wherein said compositional gradient facilitates directional charge migration from the ferroelectric core to the semiconductor shell.

10. The method of claim 1, wherein the particle size of BiVO₄ is deliberately maintained in the nanoscale range of 80-120 nm while BaTiO₃ particles are retained in the microscale range of 1-2 μm, thereby generating a hierarchical heterostructure in which nanoscale BiVO₄ particles decorate the surfaces of BaTiO₃ grains, and wherein such hierarchical structuring enhances the electrochemical double-layer capacitance to values exceeding 120 F/g; and
wherein the cooling of the calcined pellet is performed under a controlled oxygen partial pressure of 0.2-0.5 atm.

11. The method of claim 1, wherein the bandgap tunability between 2.4 eV and 3.2 eV is further refined through co-doping of the composite during synthesis by adding 0.5-2 mol % Nb₂O₅ precursor into the initial BaTiO₃ synthesis step, wherein Nb⁵⁺ ions substitute for Ti⁴⁺ within BaTiO₃, thereby inducing lattice distortion and creating shallow donor levels, wherein the resulting composite exhibits enhanced photoelectrochemical stability with photocurrent retention above 95% after 50 hours of continuous illumination.

12. The method of claim 1, wherein the BiVO₄ powder after re-calcination is subjected to wet planetary milling in ethanol medium using yttria-stabilized zirconia beads of 2-3 mm diameter for a duration of 2 hours at 400 rpm, followed by drying under rotary vacuum evaporation at 70-80° C., such that the resulting powder exhibits uniform deagglomeration prior to composite mixing.

13. The method of claim 1, wherein the BaTiO₃ powder is subjected to a controlled two-step calcination cycle, the first step comprising heating to 1000° C. at a rate of 5° C./min with a 2-hour dwell, followed by intermediate grinding, and the second step comprising reheating to 1300° C. at a rate of 10° C./min with a 4-hour dwell, wherein the two-step sequence ensures complete perovskite phase formation.

14. The method of claim 1, wherein prior to mixing, the BiVO₄ powder and BaTiO₃ powder are separately dried at 120° C. for 12 hours under vacuum in order to eliminate surface-adsorbed moisture, thereby preventing powder clumping during subsequent blending;
and wherein the mixing of BiVO₄ and BaTiO₃ powders is performed in a polyethylene jar using zirconia grinding balls with intermittent rest intervals every 30 minutes to prevent excessive heat build-up, and wherein the jar is sealed under an argon atmosphere to prevent contamination by ambient carbon dioxide or humidity during the mixing stage.

15. The method of claim 1, wherein the pressing of the mixed powders into the first pellet is achieved through cold isostatic pressing at a pressure of 200-250 MPa for 2-3 minutes, wherein the compact is subsequently wrapped in platinum foil to prevent contamination and volatilization during the high-temperature calcination step; and wherein the calcination step is carried out in an alumina crucible with a fitted lid to minimize volatilization losses, the crucible being pre-heated to 200° C. prior to loading of the pellet in order to prevent thermal shock at the onset of heating.

16. The method of claim 1, wherein the heating schedule of the calcination comprises a multi-step profile with an initial ramp of 3° C./min up to 400° C. with a 1-hour dwell, a subsequent ramp of 5° C./min up to 700° C. with a 4-hour dwell, and a final controlled cool-down at 2° C./min, wherein this sequence reduces internal stresses within the pellet during densification; and wherein the first pellet after calcination is subjected to grinding in an agate mortar followed by re-pressing and secondary calcination at 700-750° C. for 2 hours.
